(19) United States
(12) Patent Application Publication
(10) Pub. No.: US 2021/0188730 A1
(43) Pub. Date: Jun. 24, 2021

(54) SYSTEM FOR DECREASING THE DROUGHT IMPACT IN THE PERFORMANCE OF A CULTURE, METHODS FOR PREPARING THE COMPONENT I OF THE SYSTEM, METHOD FOR DECREASING THE DROUGHT IMPACT ON THE PERFORMANCE OF A CULTURE USING SUCH SYSTEM AND THE AGRICULTURAL TOOL BEING USED THEREIN

(71) Applicant: BRIX USA LLC, Newark, DE (US)

(72) Inventor: Mauricio Dobboletta, Santa Fe (AR)

(73) Assignee: BRIX USA LLC, Newark, DE (US)

(21) Appl. No.: 16/757,540

(22) PCT Filed: Oct. 22, 2018
(86) PCT No.: PCT/US2018/056866

§ 371 Date: Apr. 20, 2020

(30) Foreign Application Priority Data
Oct. 20, 2017 (AR) P 20170102931
Oct. 12, 2018 (AR) P 20180102965

(51) Int. Cl. C05G 3/40; A01C 5/06; C05G 5/20; C05G 1/00

(52) U.S. Cl. CPC C05G 3/40; C05G 1/00; C05G 5/20; A01C 5/062

(57) ABSTRACT

System for decreasing the impact of drought on the performance of a culture, comprising: a component I that is a liquid fertilizer of radicular or foliar absorption that provides protons (H+), enzymatic, activator micro elements and, optionally, nitrogen (N) or nitrogen and phosphorus (N, P) or nitrogen, sulphur, glucose, and L-tirosine as metabolic activator (N, S); and a component II which is a group of electrodes that generates an electric current that provides electrons (e) of radicular absorption. Methods for preparing the component I, the component I (N), the component I (N, P) and the component I (N, S). Method for decreasing the impact of drought on the performance of a culture using the system previously described and the agricultural tool to be used in the step a) of said method.

### FIELD OF INVENTION

This invention belongs to the field of the systems for drought resistance in plants, in particular, of those systems related to the irrigation of electrons and protons at the plants roots for drought resistance, more particularly, relates to systems of two components: a liquid fertilizer providing protons and ions and an electric circuit providing electrons to the plants roots for drought resistance, naturally supplying the components of the water photolysis without the need of any genetic handling in plants.

### DESCRIPTION OF PRIOR ART

World population increases at a great speed. One of the problems arising from this scene is how the increasing food demand being generated therefrom, is being met.

In order for the food demand to be met, an increase in the performance of the cultures will be necessary. Apart from the new technologies that are being developed around the world to achieve this object, it is essential to have an appropriate rain regime. A drought at the time of flowering of a cereal as well as the high temperatures and solar radiation drastically reduce its performance, causing severe economical damages and food shortage. A global drought could generate the greatest worldwide crisis over the time such as famines, wars, diseases, great migrations at global level.

This detailed analysis made by Aiguo Dai from the National Center for Atmospheric Research (NCAR) leads to the concerning conclusion that the increasing temperatures associated to the climate change will probably create, each time more firmly, the adequate conditions for drought, throughout the world, in the next 30 years. Besides, everything indicates that by the end of this century, in some regions the drought will reach a magnitude that has never been seen before or perhaps only in certain occasions:

By using a group of 22 climate templates by computer and an exhaustive index of drought conditions as well as an analysis of previously published studies, the new investigation indicates that most of the Occidental Hemisphere, together with wide zones of Eurasia, Africa and Australia, may be under the threat of extreme drought in this century. In contrast, certain regions of high latitudes, from Alaska to Scandinavia, are prone to become wet.

Dai advises that the results of this analysis are based on the best present projections of greenhouse gas emissions, but what is going to happen in the coming decades will depend on a lot of factors, including the future real greenhouse gas emissions as well as the behavior of the natural cycles of the climate as the meteorological phenomenon named “El Niño”.

Dai's study indicates that most of the two thirds of the occidental region of the United States will be significantly drier within 20 or 30 years. A large part of that nation may face an increasing risk of extreme drought during this century.

Among the other countries and continents that could face an increasing risk of significant drought, the following may be mentioned:
A large part of Latin America, including large areas of Mexico and Brazil.
Regions that adjoin the Mediterranean Sea, which may become specially dry.
A large area of the Southwest Asia.
Most part of Africa and Australia, with particularly dry conditions in certain regions of Africa.
Southeast Asia, including areas of China and adjacent countries.

The study has also disclosed that it is expected that during this century the risk of drought will decrease in a large part of the north of Europe, Russia, Canada and Alaska as well as in some areas in the south hemisphere. However, the planetary average will be of most serious droughts.

It has been estimated that the factors of environmental stress cause a reduction in the performance of the culture of up to 70% in comparison with the performance in favorable conditions (Boyer, Science 218, 443-448, 1982). Accordingly, the stability of the culture as regards the changes in the environmental factors is one of the most valued features for the reproduction. However, the traditional reproduction is restricted by the complexity of the features of stress tolerance, the low genetic variance of the performance components and lack of effective selection techniques. Accordingly, it may be useful to follow specific genes codifying components of stress tolerance in the reproduction by markers assisted selection as well as by genetically modified plants to be more tolerant to the stress.

Among the complexities of the reaction to the environmental stress in the culture plants, the use of the simple template for Arabidopsis offers an opportunity for the precise genetic analysis of the stress reaction pathways common to most plants. The importance of the template for Arabidopsis is evident in the recent examples of enhancement of tolerance to drought, salt and freezing (Jaglo-Ottosen et al., Science 280, 104-106, 1998; Kasuga et al., Nat. Biotechnol. 17, 287-291, 1999) by using genes identified in Arabidopsis. These genes are factors of transcription of the family ERF/AP2 that regulates the expression of several genes downstream which confer resistance to stress in different heterologous plants.

One of the most serious environmental stresses that have to be borne by the plants worldwide is the stress caused by drought or the stress caused by dehydration. Four tenths of the world areas intended for agriculture is located in waterless and semi-waterless regions. Furthermore, also the plants cultivated in regions with relatively high rains may suffer drought episodes during the growing season. Many regions intended for agriculture, especially in countries under development, systematically have short rains and depend on the irrigation to keep the performances. Water is scarce in many regions and its value will undoubtedly increase with the global warming, resulting in even a greater need of culture plants tolerant to the drought, that keep the performance levels, or even better performances, and the performance quality in conditions of little water availability.

Even though the reproduction, for example, the one assisted by markers, for drought tolerance is possible and is being applied to a variety of culture species, mainly in cereals such as corn, rainfed rice, wheat, sorghum, pearl millet, but also in other species such as caupi, guandu and alubia Phaseolus, it is extremely difficult and tedious as the tolerance or resistance to drought is a complex feature determined by the interaction of many loci and gene-environment interactions. Accordingly, there is a need to find unique, dominant genes that confer or enhance the drought tolerance and that may be easily transferred to varieties of cultures and lines of high performance reproduction. A large part of water is lost through the leaves by perspiration, and many transgenic approaches have focused on modifying the loss of water by means of a change of leaves.

For example, the document WO2000073475A1 describes the expression of a malic enzyme C4 NADP+ of the corn in epidermic cells and occlusive cells of tobacco which, according to the disclosure, increases the efficiency of the use of water in the plant modulating the stomatal aperture. Other approaches involve, for example, the expression of osmoprotectants such as sugars, such as the biosynthetic enzymes of trehalose, in plants to increase the tolerance to the water stress; see document WO1999046370A2. Other approaches have been focused on changing the architecture of the plants roots.

Up to date, another promising approach to enhance drought tolerance is the over-expression of genes CBF/DREB (DREB refers to binding to an element of response to dehydration; DRE binding) codifying several factors of transcription AP2/ERF (factor of response to ethylene); see document WO1998009521A1. The over-expression of proteins CBF/DREB1 on Arabidopsis resulted in an increase in tolerance to freezing, also referred to as tolerance to dehydration induced by freezing (Jaglo-Ottosen et al., Science 280, 104-106, 1998; Liu et al., Plant Cell 10, 1391-1406, 1998; Kasuga et al., Nat. Biotechnol. 17, 287-291, 1999; Gilmour et al. Plant Physiol. 124, 1854-1865, 2000) and improved the tolerance of the recombinant plants to the dehydration caused by hydric deficit or exhibition to a high salinity (Liu et al., 1998, supra; Kasuga et al., 1999, supra). Another factor of transcription CBF, CBF4 has been described as a regulator of the adaptation to drought on Arabidopsis (Haake et al. 2002, Plant Physiology 130, 639-648).

The document WO2004031349A2 describes a factor of transcription referred to as G1753. This reference also describes plants of transgenic culture comprising a sequence of nucleic acid codifying a protein having the sequence of factor G1753. In accordance with this reference, G1753 may be used for creating miniature forms of ornamental plants and for altering the signaling of sugar in plants.

In spite of the availability of some genes that have shown their ability to enhance the drought tolerance in a number of vegetal species, such as Brassicaceae and Solanaceae, there exists the need to identify other genes having the ability to confer or enhance the drought tolerance when expressing in culture plants.

Biotic stresses as well as pathogens such as bacteria, fungi, virus or plagues such as insects, nematodes, are the most common and, typically several mechanisms protect the plants from most of these threats. However, in certain cases, the plants show a reaction susceptible to specific pathogens or plagues and are considered hosts for those pathogens or plagues. The interaction host-pathogen has been characterized by the concept gene by gene, where specific genes of the host plant and a pathogen/plague interact with each other to exhibit a susceptible or resistant reaction. Even though the molecular genetics of such interactions has been characterized in the last years, the use of such simple resistance genes has faced difficulties due to the versatile mutation of the pathogenic system that produce the diversity to surpass the resistance genes. Generally, the resistance genes belong to a few general classes of proteins formed by additional leucine-rich repeats and domains. Even though these genes and genetic interactions are interesting to study the plant-pathogen interactions, they are not ready to be used in the protection of the cultures against a wider diversity and range of pathogens. Another way of providing resistance is the use of genes that take part in the protection of plants against a varying range of pathogens by using mechanisms that do not depend on the recognition of plants and pathogens. This would confer a specific non-racial resistance which is wider, as it would confer resistance to a wider range of pathogens.

The development of plants tolerant to stress is a strategy that have a potential to resolve or remedy, at least, some of these problems. However, the traditional strategies of plants reproduction for developing new lines of plants that exhibit resistance or tolerance to these types of stress are relatively slow and require specific resistant lines to be crossed with the desired line. The limited resources of germplasm for tolerance to the stress and the incompatibility in the crossings between species of plants remotely related represent important problems found in the conventional reproduction.

Apart from these problems, the tendency throughout the world is to consume non-transgenic products.

There exists the need, therefore, of an alternative system for drought resistance that may resolve the present problems of the art, a system applicable to any plant, a system that during drought periods may supply electrons and protons to the plants roots which is what generates the photolysis of water in those plants of oxygenic photosynthesis.

### SUMMARY OF THE INVENTION

Therefore, the object of the present invention is a system for decreasing the impact of drought on the performance of a culture, comprising:

a component I that is a liquid fertilizer of radicular or foliar absorption that provides protons (H⁺), enzymatic, activator micro elements and, optionally, nitrogen (N) or nitrogen and phosphorus (N, P) or nitrogen, sulphur, glucose, and L-tirosine as metabolic activator (N, S); and

a component II which is a group of electrodes that generates electric current providing electrons (e⁻) of radicular absorption.

Preferably, the component I a liquid fertilizer comprises sulphuric acid (98%) from about 8.0 to about 16% w/w, zinc oxide from about 0.5 to about 2.0% w/w, ferrous oxide from about 0.1 to about 1.0% w/w, magnesium oxide from about 0.1 to about 1.0% w/w and demineralised water csp 100.0% w/w.

More preferably, the component I a liquid fertilizer comprises sulphuric acid (98%) on the order of 10.0% w/w, zinc oxide on the order of 1.0% w/w, ferrous oxide on the order of 0.5% w/w, magnesium oxide on the order of 0.5% w/w, and demineralised water csp 100.0% w/w, constituting a liquid protonated fertilizer of equivalent degree NPK 0-0-0 +3.2S+0.8Zn+0.4Fe+0.3Mg+0.2H⁺.

Alternatively, the component I comprises a source of nitrogen, incorporated, in such a way that the composition is constituted in a component I (N).

Alternatively, the component I comprises a source of nitrogen and a source of phosphorous both incorporated, in such a way that the composition is constituted in a component I (N, P).

Even also alternatively, the component I comprises a source of nitrogen, a source of sulphur, glucose and L-tirosine, all of them incorporated, in such a way that the composition is constituted in a component I (N, S).

Preferably, the component I (N) comprising a source of nitrogen incorporated, comprises in solution: urea (46% of N) from about 50 to about 60% w/w, ammonium nitrate from about 2 to about 5% w/w, sulphuric acid (98%) from about 8.0 to about 16% w/w, zinc oxide from about 0.1 to about 1.0% w/w, ferrous oxide from about 0.1 to about 1.0% w/w, magnesium oxide from about 0.1 to about 1.0% w/w and demineralised water csp 100.0% w/w.

More preferably, the component I (N) comprising a source of nitrogen incorporated, comprises in solution: urea (46% of N) on the order of 54% w/w, ammonium nitrate on the order of 3% w/w, sulphuric acid (98%) on the order of 10.0% w/w, zinc oxide on the order of 0.38% w/w, ferrous oxide on the order of 0.13% w/w, magnesium oxide on the order of 0.17% w/w, and demineralised water csp 100.0% w/w, constituting a liquid fertilizer protonated of equivalent degree NPK 27-0-0 +3.2S+0.3Zn+0.1Fe+0.1Mg+0.2H⁺.

Also preferably, the component I (N, P) comprising a source of nitrogen and a source of phosphorous both incorporated, comprises in solution: mono-ammonium phosphate from about 20 to about 40% w/w, sulphuric acid (98%) from about 12.0 to about 20% w/w, zinc oxide from about 0.5 to about 2.0% w/w, ferrous oxide from about 0.1 to about 1.0% w/w, magnesium oxide from about 0.1 to about 1.0% w/w and demineralised water csp 100.0% w/w.

Also more preferably, the component I (N, P) comprising a source of nitrogen and a source of phosphorous both incorporated, comprises in solution: mono-ammonium phosphate on the order of 36% w/w, sulphuric acid (98%) on the order of 16% w/w, zinc oxide on the order of 1.0% w/w, ferrous oxide on the order of 0.5% w/w, magnesium oxide on the order of 0.5% w/w, and demineralised water csp 100.0% w/w, constituting a liquid protonated phosphorous nitrogen fertilizer of equivalent degree NPK 4-18-0 +5S+0.8Zn+0.4Fe+0.3Mg+0.33H⁺.

Also, even more preferably, the component I (N, S) of foliar application comprising a source of nitrogen, a source of sulphur, glucose and L-tirosine all of them incorporated, comprises in solution: hydrochloric acid 2 N from about 15 to about 25% w/v, ammonium sulphate from about 10 to about 25% w/v, glucose from about 10 to about 20% w/v, ethoxylated lauryl alcohol 7 moles of OE from about 5 to about 15% w/v, L-tirosine from about 0.5 to about 5% w/v, zinc oxide from about 0.5 to about 2% w/v, demineralised water csp 100.0% w/v, constituting a liquid foliar protonated nitrogen sulphurized fertilizer with metabolic and enzymatic activators of equivalent degree NPK 3.2-0-0 +3.6S+0.6Zn+0.55H⁺.

Even more preferably, the component I (N, S) of foliar application comprising a source of nitrogen, a source of sulphur, glucose and L-tirosine all of them incorporated, comprises in solution: hydrochloric acid 2 N on the order of 20%, ammonium sulphate on the order of 15% w/v, glucose on the order of 14% w/v, ethoxylated lauryl alcohol 7 moles of OE on the order of 7% w/v, L-tirosine on the order of 3.3% w/v, zinc oxide on the order of 0.7% w/v, and demineralised water csp 100.0% w/v, constituting a liquid foliar protonated nitrogen sulphurized fertilizer with metabolic and enzymatic activators of equivalent degree NPK 3.2-0-0 +3.6S+0.6Zn+0.55H⁺.

Also preferably, the component II is an electric circuit formed by two buried electrodes that are put together by one of its ends to a perimeter wire netting of the batch where the culture is located, wherein: the anode is zinc and the cathode is copper.

Preferably, the zinc anode is a wire from about 1.7 to about 5 mm of diameter buried from about 3 cm to about 7 cm in depth linearly, generating a continuous anode.

Also preferably, the copper cathode is a wire from about 1.7 to about 5 mm of diameter buried from about 3 cm to about 7 cm in depth linearly, generating a continuous cathode.

More preferably, the zinc anode is arranged with a longitudinal orientation North-South or East-West on a side of cultured batch and the copper cathode is arranged with a longitudinal orientation North-South or East-West on an opposite side of a cultured batch, in such a way that the electrodes are faced and parallel with one another.

More preferably, the zinc anode is arranged with a longitudinal orientation North-South on the East side of the cultured batch and the copper cathode is arranged with a longitudinal orientation North-South on the West side of the cultured batch, in such a way that the electrodes are faced and parallel with one another.

Even more preferably, the cathode and the anode are put together to a wire of a perimeter wire netting of the batch, said netting is parallel to said electrodes.

Another object of the present invention is a method for preparing the component I, a liquid protonated fertilizer of equivalent degree NPK 0-0-0 +3.2S+0.8Zn+0.4Fe+0.3Mg+0.2H⁺ comprised in the system to decrease the impact of the drought on the performance of a described culture, said method comprises:

a) adding sulphuric acid (98%) in demineralised water under stirring at 800 rmp and stabilizing the temperature of the solution at 25° C.;

b) adding zinc oxide, ferrous oxide and magnesium oxide under stirring, keeping stirring during 20 minutes and bringing to a volume with demineralised water; and

c) controlling the absence of a precipitate or insoluble material, and filtering the solution in a vertical filter with a mesh of 300 microns and then with a mesh of 1 micron.

Even another object of the present invention is a method for preparing the component I (N), a liquid protonated nitrogenous fertilizer of equivalent degree NPK 27-0-0 +3.2S+0.3Zn+0.1Fe+0.1Mg+0.2H⁺ comprised in the system to decrease the impact of the drought on the performance of a described culture, said method comprises:

a) adding sulphuric acid (98%) in demineralised water under stirring at 800 rpm, and then dissolving urea and keeping stirring up to complete dissolution taking advantage of the heat of dilution that was released;

b) adding ammonium nitrate keeping stirring up to total dissolution;

c) adding zinc oxide, ferrous oxide and magnesium oxide under stirring and keeping the stirring during 20 minutes and bringing to a volume with demineralised water; and

c) controlling the absence of a precipitate or insoluble material, and filtering the solution in a vertical filter with a mesh of 300 microns and then with a mesh of 1 micron.

Even another object of the present invention is a method for preparing the component I (N, P), a liquid protonated phosphorous nitrogen fertilizer of equivalent degree NPK 4-18-0 +5S+0.8Zn+0.4Fe+0.3Mg+0.33H⁺ comprised in the system to decrease the impact of the drought on the performance of a described culture, said method comprises:

a) adding sulphuric acid (98%) in demineralised water under stirring at 800 rpm, and then dissolving monoammonium phosphate and keeping stirring up to complete dissolution taking advantage of the heat of dilution that was released;

b) upon stabilization of temperature at 25° C., adding zinc oxide , ferrous oxide and magnesium oxide under stirring, keeping stirring during 20 minutes and bringing to a volume with demineralised water to compensate the vaporized water; and

c) controlling the absence of a precipitate or insoluble material, and filtering the solution in a vertical filter with a mesh of 300 microns and then with a mesh of 1 micron.

Another object of the present invention is a method for preparing the component I (N, S)), a liquid foliar protonated sulphurized nitrogen fertilizer with metabolic and enzymatic activators of equivalent degree NPK 3.2-0-0 +3.6S+0.6S+0.6Zn+0.55H⁺ comprised in the system to decrease the impact of the drought on the performance of a described culture, said method comprises:

a) adding ammonium sulphate in demineralised water under stirring at about 1,000 rpm;

b) then adding glucose under stirring;

c) then adding ethoxylated lauryl alcohol of 7 moles OE under stirring;

d) adding L-tirosine previously dissolved in hydrochloric acid 2 N also under stirring;

e) adding zinc oxide under stirring, keeping stirring during 25 minutes and bringing to a volume with demineralised water; and

f) controlling the absence of a precipitate or insoluble material, and filtering the solution in a vertical filter with a mesh of 300 microns and then with a mesh of 1 micron.

Even also another object of the present invention is a method for decreasing the impact of drought on the performance of a culture, comprising:

a) installing an anode and a cathode in a batch with an agricultural tool having a disk furrow opener, a wire attachment which is supplied with a roll at the top and a dead furrow formed by the body of a seeder, wherein the anode is a wire of zinc and the cathode is a wire of copper;

b) connecting the anode and the cathode to the wire netting of the batch;

c) sowing the batch; and

d) applying the component I or the component I (N), or the component I (N, P), in pre-emergence or post-emergence of the culture, or the component (N, S) in post-emergence of the culture.

Alternatively, the method for decreasing the impact of the drought on the performance of a culture comprises carrying out the step c) before the step a).

Preferably, the dose of application of the component I is of about 100 to about 300 kg per hectare.

Also preferably, the dose of application of component I (N) is of about 200 to about 400 kg per hectare.

Even preferably, the application is carried out in cultures of corn, sorghum, wheat, oats, barley and rainfed rice.

Also preferably, the dose of application of component I (N, P) is from about 50 to about 150 kg per hectare.

Even preferably, the application is carried out in cultures of soya bean.

Also preferably, the dose of application of the component I (N, S) is from about 200 cm³ to about 500 cm³ diluted in 50 to about 150 dm³ of water per hectare.

Even preferably, the application is carried out via foliar in cultures of soya bean, corn, sorghum, wheat, oats, barley and rainfed rice.

Preferably, the step d) of applying to the culture the component I or the component I (N), or the component I (N, P) is at a minimum from 7 days of pre-emergence to a maximum of 70 days of post-emergence of the culture, or the component I (N; S) is at a minimum from 15 days to a maximum of 70 days of post-emergence of the culture.

Preferably, the step d) of applying to the culture the component I or the component I (N), or the component I (N, P), or the component ((N, S) is carried out at 30 days of post-emergence of the culture.

In a preferred embodiment, the application of the component I or the component I (N), or the component I (N, P) is carried out by furrow blasting.

Even in a preferred embodiment, the application of the component I (N, S) is carried out via foliar by spraying of the total coverage.

Also in a preferred manner, the application of the component I or the component I (N), or the component I (N, P) is carried out by furrow blasting in a unique operation with blasting sprayer.

Also in a preferred manner, the application of the component I (N, S) is carried out via foliar at a total coverage in a unique operation with a sprayer with total coverage.

Alternatively, the application of the component I or the component I (N), or the component I (N, P) is carried out in combination with a traditional solid fertilization.

Preferably, the application of the component I is carried out together with, at least, a solid nitrogenous fertilizer as nutrient for corn, sorghum, wheat, oats, barley and rainfed rice.

Also preferably, the solid nitrogenous fertilizer is selected from urea, ammonium nitrate, ammonium sulphate, ammonium nitrate and calcium carbonate, ammonium sulphanitrate and the mixtures thereof.

Preferably, the application of the component I is carried out together with, at least, a solid phosphorous fertilizer as starter for soya bean.

Also preferably, the solid phosphorous fertilizer is selected from monoammonium phosphate (MAP), superphosphate simple (SPS), triple superphosphate or (SPT), milled rock phosphate and the mixtures thereof.

Preferably, the application of the component I (N, S) is carried out together with, at least, a compatible phytosanitary in cultures of soya bean, corn, sorghum, wheat, oats, barley and rainfed rice.

Even also another object of the present invention is an agricultural tool to be used in the step a) of the method for decreasing the impact of drought on the performance of a culture, comprising:

a horizontal chassis comprising anchorages in the front end to put together the tool to the motorized vehicle, above the chassis there are two supports which are symmetrically and transversally assembled in line and at the same height with axis, where the wires that constitute the electrodes are wrapped, and below said reels and in the middle of the chassis a wire winding is assembled for the wire to pass as the tool moves forward along the field; and

below the chassis and at the front of the tool, a furrow opener in the form of an U is centrally assembled, behind this opener two dead furrow disks are assembled inclined and faced in V and behind these disks a leveller wheel is assembled which levels out the furrow already closed, the dead furrow disks are regulated in height.

Preferably, the anchorages in front of the chassis are located on the sides and enable the tool to be anchored in a version of 3 points or in a version of dragging.

Also preferably, the structure or chassis is made of a structural pipe.

More preferably, the chassis has the following measures (40×80×4.75) cm, and is painted with epoxy paint.

In a preferred embodiment, the wires that form the electrodes are the anode which is formed by a wire of zinc and the cathode which is formed by a wire of copper.

Also in a preferred embodiment, the wires that form the electrodes anode and cathode are wires having from 1.7 to 5 mm of diameter.

### BRIEF DESCRIPTION OF FIGURES

FIG. 1 shows the climate projection with the impact of the drought in the Earth at the end of this century (source: UCAR).

FIG. 2a shows the description of the component II, an electric circuit formed by electrodes Zn/Cu located in a culture batch.

FIG. 2b shows where the copper electrode is installed (cathode) located to the West of a culture of corn of the application example 3.

FIG. 3 shows the system of measurements of currents installed in the culture of corn of the example 6, it is fed by a solar panel, and the testers measure the intensity of current and the voltage between the electrodes Zn/Cu of the electric circuit of the component II.

FIG. 4a shows a measurement of current on a culture of corn of the example 6.

FIG. 4b shows another measurement of current on a culture of corn of the example 6.

FIG. 4c even shows another measurement of current on a culture of corn of the example 6.

FIG. 5a shows the trial and its comparative results of a test of hydric stress due to drought with plants of corn in pots of the example of application 1.

FIG. 5b shows the trial and its comparative results of a test of hydric stress due to drought with plants of soya bean in pots of the example of application 2.

FIG. 5c shows the trial and its comparative results of a test of hydric stress due to drought with plants of wheat in pots of the example of application 3.

FIG. 6a shows the trial in field of the drought resistance of the example of application 4.

FIG. 6b shows the trial in field of the drought resistance of the example of application 4 exhibiting the difference between the treatments with and without electroprotonic irrigation, at the left and at the right of the figure, respectively.

FIG. 7a shows the performance expressed in kg of corn/hectare (kg/ha) of the trial of the example of application 4.

FIG. 7b shows the difference in kg/ha with respect to the Witness T1 of the trial of the example of application 4.

FIG. 8a shows the performance expressed in kg of corn/hectare (kg/ha) of the trial of the comparative example 4.

FIG. 8b shows the difference in kg/ha with respect to the Hybrid Witness of the trial of the comparative example 4.

FIG. 9 shows the comparative trial of resistance to drought in corn as compared to the corn resistant to drought identified as DEKALB DKC 5741 of the comparative example 1.

FIG. 10 shows the comparative trial of resistance to drought in corn as compared to the corn resistant to drought identified as KWS KEFIEROS FAO700 of the comparative example 2.

FIG. 11a shows the trial in field of the drought resistance of the comparative example 3 between T1 and T2, left and right, respectively.

FIG. 11b shows the trial in field of the drought resistance of the comparative example 3 between T3 and T4, left and right, respectively.

FIG. 12 shows the performance expressed in kg of corn/hectare of the trial of the comparative example 3.

FIG. 13 shows the performance expressed in kg of soya bean/hectare of the trial of the comparative example 7.

FIG. 14 shows the trial of optimum Cartesian orientation of the component II in wheat.

FIG. 15 shows a superior perspective view of the agricultural tool to be used in the method for decreasing the impact of drought on the performance of a culture according to the present invention.

FIG. 16 shows a front side perspective view of the agricultural tool to be used in the method for decreasing the impact of drought on the performance of a culture according to the present invention.

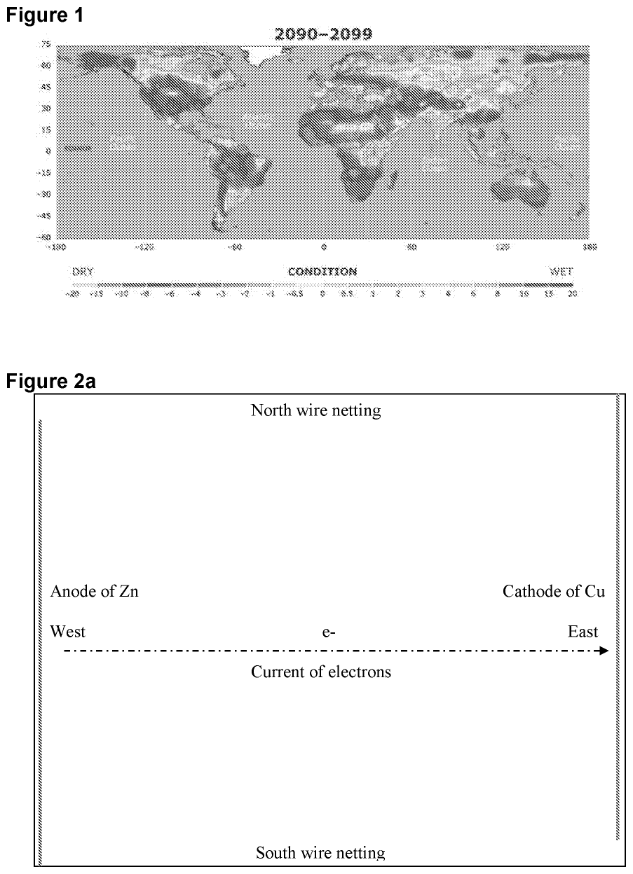

### DETAILED DESCRIPTION OF THE INVENTION

Therefore, the object of the present invention is to decrease the impact of drought on the performance of the cultures.

As we know, these cultures perform oxygenic photosynthesis, where the giver of electrons is water. At the photosystem II the water photolysis is made where the water molecule (H₂O) rupture is produced by the oxidizing action of the pigment p680+ releasing two electrons (2e⁻), two protons (2H⁺) with the release of atomic oxygen (O) which will be combined with the oxygen of another water molecule and will be released as gaseous oxygen by the stomates.

H₂O→2H⁺+2e⁻+1/2O₂

This invention comprises of a system of two components of radicular absorption that will provide electrons (e⁻) to the transport of electrons and protons (H⁺) to the transport of protons for the phases of light of the photosynthesis during water stress and droughts.

The first one is the component I, a liquid protonated fertilizer of equivalent degree NPK 0-0-0 +3.2S+0.8Zn+0.4Fe+0.3Mg+0.2H⁺, where, depending on the equivalent degree, N refers to % w/w of nitrogen, P refers to % w/w of phosphorous expressed in phosphorous pentoxide (P₂O₅), K refers to % w/w of potassium, S refers to % w/w of sulphur, Zn refers to % w/w of zinc, Fe refers to % w/w of iron, Mg refers to % w/w of magnesium, H⁺ refers to % w/w of protons which is a liquid fertilizer of radicular or foliar absorption providing protons (H⁺) together with enzymatic activators micro elements and, optionally, nitrogen or nitrogen and phosphorous, or nitrogen and sulphur together with glucose and L-tirosine as metabolic activator; and

a component II which is a system of electrodes that generates an electric current that provides electrons (e⁻) of radicular absorption.

According to the present invention, the following provided to the plant by radicular absorption:

i)—electrons (e) and protons (H⁺) to compensate the water photolysis to keep the photosystems operating and to keep the ATP synthase and the generation of energy (ATP).

ii)—Magnesium cations (Mg²⁺), ferrous iron (Fe²⁺), zinc (Zn²⁺) and sulphate anions (SO₄²⁻) as activators of the enzymes catalase and ribulose-1,5-biphosphate carboxilase oxygenase (RuBisCo9 and for the synthesis of chlorophyll achieving a greater photosynthetic efficacy. The sulphate anion (SO₄²⁻) is important for the protein synthesis.

iii)—Additionally, nitrogen (N) as the most important nutrient in the nutrition, production of biomass, being required by cultures as corn, wheat, sorghum, oats, barley and rice.

iv)—Additionally to the nitrogen, phosphorous (N, P) as important nutrient for the storage and transference of energy, particularly required by the soya bean culture.

v)—Additionally to the nitrogen, in some embodiments of the invention, sulphur (N, S) which is important for the proteins synthesis together with glucose (C₆H₁₂O₆) as source of energy and L-tirosine ((C₉H₁₁NO₃) as metabolic activator, being this combination suitable for an application via foliar on any culture such as soya bean, corn, wheat, sorghum, oats, barley and rice.

Particularly, the combination of i) and ii) allows obtaining an activator of catalase enzymes and RuBisCo, and for the synthesis of chlorophyll with magnesium and iron that gets a better absorption of solar energy increasing the activity of the photosynthesis and producing a plant with greater metabolic activity and greater efficiency in the photo acyclic phosphorilation by excess of electrons, as with the same number of sun photons, having a radicular electronic (e⁻) stimulation and introducing protons (H⁺) to compensate the water photolysis and to keep the photosystems operating, the excess of protons is used to keep the enzyme ATP synthase and the generation of energy (ATP) active which are necessary to keep the photosynthesis.

The present invention is applicable to the plants of C4 photosynthesis such as corn, sorghum, tomato, among others, as well as to plants of C3 photosynthesis such as wheat, soya bean, barley, rice, among others.

The component I of the proposed system is a liquid protonated fertilizer of equivalent degree NPK 0-0-0 +3.2S+0.8Zn+0.4Fe+0.3Mg+0.2H⁺.

This product of radicular absorption provides the necessary protons (H⁺) for the generation of ATP and the zinc cation (Zn²⁺) operating as radicular fertilizer of essential importance in the development of the culture, being zinc a metallic activator of the enzymes and taking part in the synthesis of the indoleacetic acid. It also performs electric operations before its radicular absorption, catalizing the Zn/Cu stack, in the diffusion of electrons on the soil. The magnesium cation (Mg²⁺) performs electric operations at the beginning and fertilizing operations of nutrition when being adsorbed by the root. The most important function in the plants is to be a part of the chlorophill molecule, so it is actively involved in the photosynthesis process. However, in this role, only from 15 to 20% of the total magnesium of the leaves is involved. The magnesium activates more enzymes than any other element in the plant. It has important enzymatic actions, specially related to the process of CO₂ fixation.

In effect, the magnesium specifically activates the enzyme ribulose 1,5 biphosphate carboxilase oxygenase (RuBisCo), increasing its affinity to incorporate CO₂. That's why the positive effect of the magnesium in the assimilation of CO₂ and the associated processes such as the production of sugars and starch. It also takes part in a series of vital processes for the plants requiring energy, such as the photosynthesis, breathing, and synthesis of macromolecules such as carbohydrates, proteins and lipids.

It has also an important structural role in the pectins, though in a very lesser amount of calcium and, lastly, it is an integral part of the ribosome.

The sulphate ion (SO₄²⁻) has several functions: enhances the efficiency of the nitrogen, is indispensable for the synthesis of amino acids containing sulphur and influences over the total synthesis of the proteins, important active enzymes in the energetic metabolism and that of the fatty acids. It is a component of the protein of the chloroplast, is a component of the B1 vitamin, present in the cereal grains, and is important in the production of substances such as phytoalexin, glutathione, necessary in the mechanisms for the defense of the plant. On the soil, it takes part in the exchange of aluminum phosphates, iron and calcium to get an increased availability of these elements in the plants, specially the essential elements such as iron and calcium. All this is always controlled so as not to compete with the magnesium absorption.

In a preferred embodiment, the component I, a liquid protonated fertilizer of equivalent degree NPK 0-0-0 +3.2S+0.8Zn+0.4Fe+0.3Mg+0.2H⁺ of the present invention, is a composition comprising sulphuric acid (98%) from about 8.0 to about 16% w/w, preferably on the order of 10.0% w/w; zinc oxide from about 0.5 to about 2.0% w/w, preferably on the order of 1.0% w/w; ferrous oxide from about 0.1 and about 1.0% w/w, preferably on the order of 0.5% w/w; magnesium oxide from about 0.1 and about 1.0% w/w, preferably on the order of 0.5% w/w; and demineralised water csp 100.0% w/w.

The sulphuric acid is the source of protons (H⁺) and of sulphate ion (SO₄²⁻) per mol of sulphuric H₂SO₄. The ferrous oxide is the source of ferrous ions (Fe²⁺). The zinc oxide is the source of magnesium ions (Mg²⁺). The zinc oxide is the source of zinc cations (Zn²⁺).

Another object of the present invention is a method for preparing the component I, a liquid protonated fertilizer of equivalent degree NPK 0-0-0 +3.2S+0.8Zn+0.4Fe+0.3Mg+0.2H⁺ providing protons and enzyme activator micro elements for the resistance to drought, according to what was previously described, wherein said method comprises the steps of:

a) adding sulphuric acid (98%) in demineralised water under stirring at about 800 rmp and stabilizing the temperature of the solution at 25° C.;

b) adding zinc oxide , ferrous oxide and magnesium oxide under stirring, keeping stirring during 20 minutes and bringing to a volume with demineralised water to compensate; and

c) controlling the absence of a precipitate or insoluble material, and, then, filtering the solution in a vertical filter with a mesh of 300 microns and then with a mesh of 1 micron.

After obtaining the desired liquid composition of fertilizer, it is analyzed to check that it is in conditions to be stored in storage tanks suitable for liquid fertilizers. The product is commercialized in bulk or in a mixture with nitrogenous liquid fertilizers for its application in the stage of growth in plants of corn, sorghum, wheat, oats, barley and rainfed rice or with nitro phosphorous fertilizers for its application as starter for soya bean.

The recommended dose of application is from 100 to 300 kg per hectare.

The time of application is of about 7 before sowing up to 70 days after emergence. Preferably, application should be made about 30 days after the emergence. The application is made by furrow blasting, preferably in a unique application, with fertilizers suitable for the handling of liquid fertilizers.

Preferably, the application is made with nitrogenous or phosphorous liquid fertilizers, or in combination with the traditional solid fertilization.

In a preferred embodiment of the component I, a liquid fertilizer mixed with at least a nitrogenous component constituting a component I (N), a liquid protonated nitrogenous fertilizer of equivalent degree NPK 27-0-0 +3.2S+0.3Zn+0.1Fe+0.1Mg+0.2H⁺, which in order to get an efficient implementation of the present invention is applied in a unique operation with blasting sprayer to the cultures of corn, wheat, rainfed rice, barley, sorghum and oats, among others, being the same a composition comprising urea (46% of N) from about 50 to about 60% w/w, preferably on the order of 54% w/w; ammonium nitrate from about 2 to about 5% w/w, preferably on the order of 3% w/w; sulphuric acid (98%) from about 8.0 to about 16% w/w, preferably on the order of 10.0% w/w; zinc oxide from about 0.10 to about 1.0% w/w, preferably on the order or 0.38% w/w; ferrous oxide from about 0.10 to about 1.0% w/w, preferably on the order of 0.13% w/w; magnesium oxide from about 0.10 to about 1.0% w/w, preferably on the order of 0.17% w/w; and demineralised water csp 100.0% w/w.

The sulphuric acid is the source of protons (H⁺) and of sulphate ions (SO₄²⁻) per mol of sulphuric H₂SO₄. The ferrous oxide is the source of ions of ferrous iron (Fe²⁺). The zinc oxide is the source of magnesium ions (Mg²⁺). The zinc oxide is the source of zinc cations (Zn²⁺). The urea and the ammonium nitrate are the source of nitrogen (N) in its forms amido, ammonium and nitrate.

Another object of the present invention is a method for preparing the composition of the component I (N), a liquid protonated nitrogenous fertilizer of equivalent degree NPK 27-0-0 +3.20S+0.3Zn+0.1Fe+0.1Mg+0.20H⁺ providing protons, enzyme and nitrogen activators for the resistance to drought, according to what was previously described, said method comprises the steps of:

a) adding sulphuric acid (98%) in demineralised water under stirring at about 800 rpm, and then, taking advantage of the heat of dilution that was released, dissolving urea and keeping stirring up to complete dissolution.

b) adding ammonium nitrate keeping stirring up to total dissolution;

b) adding zinc oxide, ferrous oxide and magnesium oxide under stirring, keeping stirring during about 20 minutes and bringing to a volume with demineralised water to compensate the vaporized water; and

c) controlling the absence of a precipitate or insoluble material, and, then, filtering the solution in a vertical filter with a mesh of 300 microns and then with a mesh of 1 micron.

After obtaining the desired liquid composition of fertilizer, it is analyzed to check that it is in conditions to be stored in storage tanks suitable for liquid fertilizers. The product is commercialized in bulk for its application in the stage of growth in plants of corn, sorghum, wheat, oats and barley and rainfed rice.

The recommended dose of this component I (N) is from 200 to 400 kg per hectare.

The time of application is from a minimum of about 7 days of pre-emergence up to a maximum of about 70 days after emergence. Preferably, application should be made about 30 days after the emergence. The application is made by furrow blasting, preferably in a unique application, with fertilizers suitable for the handling of liquid fertilizers.

Even in another preferred embodiment of the component I, a liquid fertilizer mixed with at least a phosphorous nitrogen component constituting a component I (N, P), a liquid, protonated phosphorous nitrogen fertilizer of equivalent degree NPK 4-18-0 +5S+0.8Zn+0.4Fe+0.3Mg+0.33H⁺, which in order to get an efficient implementation of the present invention is applied in a unique operation with blasting sprayer to the cultures of soya bean as starter, and comprises monoammonium phosphate from about 20 to 40% w/w, preferably on the order of 36% w/w; sulphuric acid (98%) from about 12.0 to about 20% w/w, preferably on the order of 16.0% w/w; zinc oxide from about 0.5 to about 2.0% w/w, preferably on the order of 1.0% w/w; ferrous oxide from about 0.1 to about 1.0% w/w, preferably on the order of 0.5% w/w; magnesium oxide from about 0.10 to about 1.0% w/w, preferably on the order of 0.5% w/w; and demineralised water csp 100.0% w/w.

In the same way, the sulphuric acid is the source of protons H⁺ and of sulphate ions (SO₄²⁻) per mol of sulphuric H₂SO₄. The ferrous oxide is the source of ions of ferrous iron (Fe²⁺). The zinc oxide is the source of magnesium ions (Mg²⁺). The zinc oxide is the source of zinc cations (Zn²⁺). The monoammonium phosphate is the source of phosphorous (P) in the form of phosphate and also of nitrogen (N) as ammonium.

Another object of the present invention is a method for preparing the composition of the component I (N, P), a liquid protonated phosphorous nitrogen fertilizer of equivalent degree NPK 4-18-0 +5S+0.8Zn+0.4Fe+0.3Mg++0.33H⁺, providing protons, sulphur, enzyme activators, phosphorous and nitrogen for the resistance to drought in plants, according to what was previously described, said method comprises the steps of:

a) adding sulphuric acid (98%) in demineralised water under stirring at about 800 rpm, and then, taking advantage of the heat of dilution that was released, dissolving mono-ammonium phosphate, keeping stirring up to complete dissolution.

b) upon stabilization of temperature at 25° C., adding zinc oxide, ferrous oxide and magnesium oxide under stirring, keeping stirring during about 20 minutes and bringing to a volume with demineralised water to compensate the vaporized water; and

c) controlling the absence of a precipitate or insoluble material, and, then, filtering the solution in a vertical filter with a mesh of 300 microns and then with a mesh of 1 micron.

After obtaining the desired liquid composition of fertilizer, it is analyzed to check that it is in conditions to be stored in storage tanks suitable for liquid fertilizers. The product is commercialized in bulk for its application in the stage of growth in plants of soya bean.

The recommended dose of this component I (N, P) is from about 50 to about 150 kg per hectare.

The time of application is of about 7 before sowing up to 70 days after the emergence. Preferably, application should be made about 30 days after the emergence. The application is made by furrow blasting, preferably in a unique application, with fertilizers suitable for the handling of liquid fertilizers.

Still in another preferred embodiment of the component I, a liquid fertilizer mixed with at least a source of nitrogen, at least a source of sulphur, glucose and L-tirosine, all of them incorporated, constituting a component I (N, S), a liquid protonated sulphurized nitrogen fertilizer of equivalent degree NPK 3.2-0-0 3.6S0.6Zn+0.55H⁺, which, in order to achieve an efficient implementation of the present invention is applied via foliar in a unique operation with sprayer of total coverage to the cultures of soya bean, corn, wheat, rainfed rice, barley, sorghum and oats, among others, being the same a composition comprising hydrochloric acid 2 N from about 15 to about 25% w/v, ammonium sulphate from about 10 to about 25% w/v, glucose from about 10 and about 20% w/v, ethoxylated lauryl alcohol 7 mols of OE from about 5 to about 15% w/v, L-tirosine from about 0.5 to about 5% w/v, zinc oxide from about 0.5 to about 2% w/v, and demineralised water csp 100.0% w/v.

In the same way, the hydrochloric acid is the source of protons H⁺. The ammonium sulphate is the source of N from the ions (NH₄⁺) and of S from the sulphate ions (SO₄²⁻) per mol of ammonium sulphate (NH₄)₂SO₄. The zinc oxide is the source of zinc cations (Zn²⁺). The glucose (C₆H₁₂O₆) is incorporated as a source of energy and the L-tirosine (C₉H₁₁NO₃) as a metabolic activator.

Another object of the present invention is a method for preparing the component I (N, S), a liquid foliar protonated sulphurized nitrogen fertilizer with metabolic and enzymatic activators of equivalent degree NPK 3.2-0-0 +3.6S+0.6Zn+0.55H⁺, providing protons, nitrogen, sulphur, metabolic and enzymatic activators, to give resistance and decrease the impact of drought enhancing the performance of the cultures of plants, according to what was previously described, said method comprises the steps of:

a) adding ammonium sulphate in demineralised water under stirring at about 1,000 rpm;

b) then adding glucose under stirring;

c) then adding ethoxylated lauryl alcohol of 7 moles OE under stirring;

d) adding L-tirosine previously dissolved in hydrochloric acid 2 N also under stirring;

e) adding zinc oxide under stirring, keeping stirring during 25 minutes and bringing to a volume with demineralised water; and

f) controlling the absence of a precipitate or insoluble material, and filtering the solution in a vertical filter with a mesh of 300 microns and then with a mesh of 1 micron.

After obtaining the desired liquid composition of fertilizer, it is analyzed to check that it is in conditions to be fractioned in barrels suitable for liquid fertilizers. The product is commercialized in fractions in barrels of 5 dm³ for its dilution to the suitable dose at the time of its utilization and further application in the stage of the plants growth of the object cultures.

The dose recommended of this component I (N, S) is from about 200 to about 500 cm³, diluted in about 50 to about 150 dm³ of water per hectare.

The time of application is from about 15 days after emergence up to 70 days after emergence. Preferably, application should be made about 30 days after the emergence. The application is made via foliar by spraying of total coverage, preferably in a unique operation, with a sprayer of total coverage.

The component II of the system, according to the present invention, is an electric circuit formed by two buried electrodes that form an antenna with the wire netting of the batch.
Anode: zinc Zn→Zn²⁺+2e⁻ 0.760 V oxidation
Cathode: copper Cu²⁺+2e⁻→Cu −0.340 V reduction

The zinc anode is a wire of zinc of 1.7 to 5 mm of diameter which is buried at a determined depth into the soil in a linear way, using an agricultural tool manufactured for this purpose, having a disk furrow opener, a wire attachment, which is supplied with a roll at the top, a dead furrow and a leveller wheel. This agricultural element is dragged by a tractor, generating a continuous anode. The cathode of wire of copper is from about 1.7 to about 5 mm of diameter and is placed in the same way as the anode, parallel thereto, in the other end of the field.

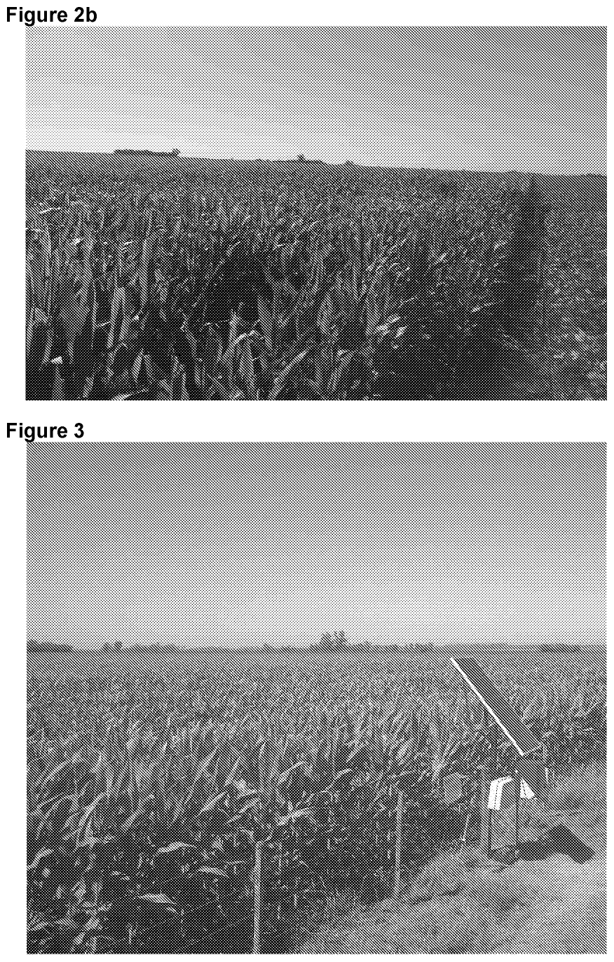

The depth to which the electrodes are buried depends on the type of culture, particularly it is related to the development of the culture roots to be stimulated. In wheat and soya bean, for example, depths of electrodes comprising a range among 3 to 7 cm may be used. For corn, the depth which is on the order of 7 cm is suitable. There is no limit of separation between both electrodes. This is shown in FIGS. 2a and 2b.

For example, the zinc anode is arranged at the West of the cultured batch and the copper cathode is at the East. In this way, the electrons will have, then, an orientation of circulation from West to East among the sides of the cultured batch, in such a way that they cross along with the lines of the magnetic field of the soil, generating a current of electrons on the order of μA an equivalent to 1.6×10¹¹ electrons, which are sufficient to supply the current of electrons necessary to replace the water photolysis of the photosystem II.

In a preferred embodiment of the invention, the south end of the zinc anode binds to one or several wires of the south wire netting and the north end of the copper cathode joins to one or several wires of the north wire netting, thus generating a kind of antenna that captures energy from the environment, of the atmosphere, such as static, among others, according to what is shown in FIG. 2a.

The arrangement of the antenna was achieved from a trial in a pot where wires of about 25 cm of length in an L form were used, they were buried at about 7 cm and the large part was left as an antenna to carry out the measurements of the current intensity in the trial. With this arrangement, a surprisingly unexpected result was obtained when by cutting said antennas the plants got dry in a very few days and those that remained operating were kept green and with resistance to drought.

Also, another object of the present invention is an agricultural tool (1) to place the wires working as anode and cathode of a batch.

Said agricultural tool (1) is a machine designed to put a wire working as electrode on the soil and then to cover it. This machine may be designed in a three points version or for dragging

Said agricultural machine (1) has a disk furrow opener (2), a wire winding (3), which is supplied with a reel (4), arranged at the top of the tool (1) and a dead furrow (5), constituted by two disks which are inclined and faced to each other and a leveller wheel (6), wherein the anode is a zinc wire and the cathode is a copper wire.

The elements constituting the tool (1) are assembled on a hinged structure or chassis (7) that may take a semi lateral working position, which allows the task to be carried out near the fence.

The first operation consists of penetrating the soil and opening a furrow where the electrode is being placed as the tool (1) moves forward.

At the top there exist two axis (8) that allow arranging each reel (4) where the electrodes are wrapped.

The wrapped electrodes are guided and pass through a wire winding (3), which role is to guide the electrode up to its final arrangement in the furrow without damage.

The land at the sides of the furrow is covered by two dead furrow wheels (5) which are inclined allowing the coverage of the electrode within the furrow with the possibility of being adjusted at a determined height.

At the last stage of the process of installation of the electrodes, the tool (1) levels the land that was removed with a leveller wheel (6) located at the rear part thereof.

Therefore, the agricultural tool (1) for placing a wire in a field comprises a structure or horizontal chassis (7) comprising anchorages (9) at the front end to bind together the tool (1) to a motorized vehicle, above the chassis (7) there are two supports (10) which are symmetrically and transversally assembled in line and at the same height with axis (8) that hold reels (4), where the wires that constitute the electrodes are wrapped, and below said reels (4) and in the middle of the chassis (7) a wire winding (3) is assembled for the wire to pass as the tool (1) moves forward along the field.

Below the chassis (7) and at the front of the tool (1), a furrow opener (2) in the form of an U is centrally assembled, behind this opener two dead furrow disks (5) are assembled inclined and faced in V and behind these disks a leveller wheel (6) is assembled which levels out the furrow already closed, where the dead furrow disks (5) are regulated in height.

The anchorages (9) in front of the chassis are located at the sides and enable the tool (1) to be anchored in a version of 3 points or in a version of dragging.

The version of 3 points is a combination of a superior bar o third point with two bars or inferior arms, all of which are brought together in their two ends and keeping together the agricultural tool (1) to the motorized vehicle, for example, a tractor, allowing said vehicle to be raised by means of an hydraulic system. Particularly, it may be assembled at the rear part of a motorized vehicle.

The dragging version allows the tool (1) to be dragged with a motorized vehicle, for example, a tractor, by means of a horizontal bar used for the vehicle to be fastened to the towed tool (1).

The chassis (7) is manufactured with a structural tube, preferably, of 40×80×4.75 cm, which is, preferably, painted with epoxy paint

### EXAMPLES

### Example 1: Manufacturing of Component I, a Liquid Protonated Fertilizer of Equivalent Degree NPK 0-0-0 +3.2S+0.8Zn+0.4Fe+0.3Mg+0.2H⁺

At the reactor with stirring of 10 tn, 10,000 kg of the component I, a liquid protonated fertilizer were manufactured.

A stainless steel reactor of 316 L was loaded with 8,800 kg of demineralised water, it was provided with an axis with a stirrer disk of four blades which caused a stirring at 800 rpm, and 1,000 kg of sulphuric acid (98%) were slowly added, keeping stirring and, once stabilized the temperature at 25° C., 100 kg of zinc oxide, 50 kg of ferrous oxide and 50 kg of magnesium oxide were added.

Stirring was kept during 20 minutes and was brought to a volume with demineralised water to compensate the vaporized water. The absence of a precipitate or insoluble material was controlled. Then, the solution was filtered in a vertical filter with a mesh of 300 microns and then the filtering operation was repeated with a mesh of 1 micron.

### Example 2: Manufacturing of Component I (N), a Liquid Protonated Nitrogenous Fertilizer of Equivalent Degree NPK 27-0-0 +3.20S+0.3Zn+0.1Fe+0.1Mg+0.20H³⁰

At the reactor with stirring of 10 tn, 10,000 kg of the component I, a liquid protonated nitrogenous fertilizer was manufactured.

A stainless steel reactor of 316 L was loaded with 3,232 kg of demineralised water, it was provided with an axis with a stirrer disk of four blades which caused a stirring at 800 rpm, and 1,000 kg of sulphuric acid (98%) were slowly added, keeping stirring and, taking advantage of the heat of dilution which was produced, 5,400 kg of urea (46% of N) were dissolved keeping stirring up to complete dilution. Then, 300 kg of ammonium nitrate were added and stirring was kept up to total dissolution. Once stabilized the temperature at 25° C., 38 kg of zinc oxide, 13 kg of ferrous oxide and 17 kg of magnesium oxide were added.

Stirring was kept during 20 minutes and was brought to a volume with demineralised water to compensate the vaporized water. The absence of a precipitate or insoluble material was controlled. Then, the solution was filtered in a vertical filter with a mesh of 300 microns and then the filtering operation was repeated with a mesh of 1 micron.

### Example 3: Manufacturing of Component I (N, P), a Liquid Protonated Phosphorous Nitrogen Fertilizer of Equivalent Degree NPK 4-18-0 +5S+0.8Zn+0.4Fe+0.3Mg+0.33H⁺

At the reactor with stirring of 10 tn, 10,000 kg of the component I (N, P), a liquid phosphorous fertilizer were manufactured.

A stainless steel reactor of 316 was loaded with 4,600 kg of demineralised water, it was provided with an axis with a stirrer disk of four blades which caused a stirring at 800 rpm, and 1,600 kg of sulphuric acid (98%) were slowly added while keeping the stirring. Next, 3,600 kg of monoammonium phosphate were added and, once stabilized the temperature at 25° C., 100 kg of zinc oxide, 50 kg of ferrous oxide and 50 kg of magnesium oxide were added.

Stirring was kept during 20 minutes and was brought to a volume with demineralised water to compensate the vaporized water. The absence of a precipitate or insoluble material was controlled. Then, the solution was filtered in a vertical filter with a mesh of 300 microns and then the filtering operation was repeated with a mesh of 1 micron.

### Example 4: Manufacturing of Component I (N, S) a Liquid Foliar Protonated Nitrogen Sulphurized Fertilizer with Metabolic and Enzymatic Activators of Equivalent Degree NPK 3.2-0-0 +3.6S+0.6Zn+0.55H⁺

At a reactor with stirring, 10,000 dm³ of component I (N, S) a liquid foliar protonated nitrogen sulphurized with metabolic and enzymatic activators were manufactured.

A stainless steel reactor of 316 was loaded with 4,000 dm3 of demineralised water, it was provided with an axis with a stirrer disk of four blades which caused a stirring at 1,000 rpm and 1,500 kg of ammonium sulphate were slowly added and stirring was kept. Next, 1,400 kg of glucose with stirring was added, 700 kg of ethoxylated lauryl alcohol of 7 mols OE were added. Next, 330 kg of L-tirosine previously dissolved in 2,000 kg of hydrochloric acid 2 N also under stirring were added. Furthermore, 70 kg of zinc oxide with stirring were added.

It was brought to a final volume of 10,000 dm³ with demineralised water and stirring was kept during 25 minutes. The absence of a precipitate or insoluble material was controlled. Then, the solution was filtered in a vertical filter with a mesh of 300 microns and then the filtering operation was repeated with a mesh of 1 micron.

### Example 5: Trial of Optimum Cartesian Orientation of the Component II

The trial consisted of plastic pots, all of them of the same size of 10 cm of diameter, 7.85×10⁻³ m² containing 4 plants of wheat at the same vegetative stage. Plants were irrigated during 1 day and then water was suspended during 10 days and measurements were taken.

On day 1 of the trial the zinc and copper electrodes in the form of an L were buried in each end of the pot in a parallel way with the antennas upwards as it is shown in FIG. 13, with a north and south orientation, at a depth between 3 and 4 cm.

The trial consisted of determining, if any, an optimum Cartesian position of the component II, for which the emf (electromotive force) of the electrodes was measured as well as the current flow at the four cardinal points by rotating the pot in order to direct the zinc electrode to the East, North, West and South.

TABLE 1
Measurement of the electromotive force of the component II,
according to the orientation of the zinc electrode

| Measurement | Emf (mV) | | | |
|---|---|---|---|---|
| No. | East | North | West | South |
| 1 | 506.0 | 510.0 | 477.0 | 474.0 |
| 2 | 512.0 | 496.0 | 510.0 | 500.0 |
| 3 | 482.0 | 502.0 | 499.0 | 468.0 |
| 4 | 512.0 | 482.0 | 499.0 | 505.0 |
| 5 | 502.0 | 509.0 | 500.0 | 497.0 |
| Average | 502.8 | 499.8 | 497.0 | 488.8 |

TABLE 2
Measurement of the current flow of the component
II, according to the orientation of the zinc electrode

| Measurement | Current flow (mV) | | | |
|---|---|---|---|---|
| No. | East | North | West | South |
| 1 | 21.3 | 15.1 | 16.1 | 14.5 |
| 2 | 20.7 | 14.0 | 17.2 | 12.8 |
| 3 | 18.3 | 15.4 | 14.7 | 16.0 |
| 4 | 18.9 | 16.4 | 15.3 | 13.0 |
| 5 | 19.7 | 17.8 | 17.7 | 15.7 |
| Average | 19.78 | 15.74 | 16.20 | 14.40 |

As it can be seen in tables 1 and 2, the component II works in any of the four directions, getting the greatest values of emf and current flow with the orientation of the zinc electrode to the East and the copper electrode to the West, being, therefore, this last one the optimum orientation of operation of the component II.

### Example 6: Trial of the Component II, an Electric Circuit Formed by Electrodes Zn/Cu

Trials were made in order to determine the behavior of the current recirculated in the land, points of energy collection and if it is feasible, applying pre-established formulas such as, for example, the Ohm's Law.

At an area of the field of about 20 m² of surface, where only grasses of 5 by 4 meters appear, voltages and currents got from the land were tested with 2 wire electrodes, one of zinc and the other one of copper to generate an emf, and another of zinc in order to take data based on the distances, taking as a reference point the negative electrode.

The electrodes used were buried at a depth on the order of 5 cm.

The time of the trial performance was the same moment as the one on which the component I was applied, and up to the senescence of the culture.

The conditions for the trial were the following: the temperature of the land at 10 cm of depth was of 24° C.; the linear distance among injector electrodes (patterns) was of 4 meters, the current of shortcircuit was of 0.58 μA; and the voltage between the terminals without load (emf) A-E was of 370 mV.

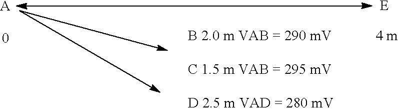

By placing among the electrodes a resistance R near 0 Ohm (Ω) the following data was obtained:

TABLE 3
Voltage as regards the distance
among the injector electrodes

| Distance | Voltage |
|---|---|
| (m) | (mV) |
| 0.1 | 260 |
| 0.5 | 290 |
| 0.8 | 300 |
| 1.0 | 290 |
| 1.5 | 295 |
| 2.0 | 290 |
| 2.5 | 280 |
| 3.0 | 295 |
| 3.2 | 300 |
| 3.5 | 220 |
| 3.9 | 120 |

Conclusions: As from the results obtained, it may be deduced that:

1—the land behaves as a enormous resistance.

2—It is acceptable to apply the Ohm's Law for approximate calculations in this type of trials.

### Example 7: Trial of the Electric Behavior of the Electroprotonic Irrigation System in a Batch of Late Maturing Corn

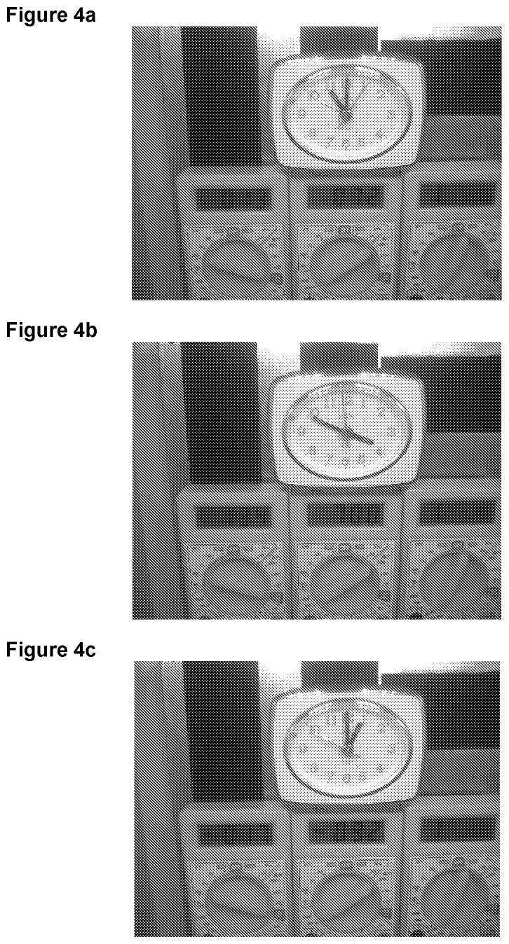

Trials were made in order to determine the behavior of the current recirculated in the land in a corn batch. To this effect, the electrodes were placed, according to the previously mentioned description of the component II and were monitored with a tester as shown in FIGS. 3, 4a, 4b and 4c. The voltage in millivolts (mV) and the current flow in microamperes (μA) were measured as from the date of sowing up to its senescence. Several rains were registered. In table 4 two examples of rains may be observed at 52 days at the vegetative stage and at 107 days at the flowering stage.

TABLE 4
Measurement of current at the corn batch

| Day | Time | mV | μA | Stage (external factors) |
|---|---|---|---|---|
| 1 | | | | Sowing |
| 51 | 19:40 | 19 | 100 | Vegetative stage |
| 51 | 8:30 PM | 18 | 103 | Vegetative stage |
| 51 | 8:45 PM | 19 | 106 | Vegetative stage |
| 52 | 6:14 AM | 28 | 152 | Vegetative stage |
| 52 | 6:28 AM | 28 | 154 | Vegetative stage |
| 52 | 6:45 AM | 28 | 153 | Vegetative stage |
| 52 | 7:02 AM | 27 | 150 | Vegetative stage |
| 52 | 7:30 AM | 28 | 154 | Vegetative stage |
| 52 | 8:00 AM | 27 | 146 | Vegetative stage |
| 52 | 8:30 AM | 155 | 833 | Vegetative stage (strong rain) |
| 52 | 7:15 PM | 58 | 326 | Vegetative stage |
| 52 | 7:30 PM | 62 | 329 | Vegetative stage |
| 107 | 2:00 AM | 26 | 136 | Flowering stage |
| 107 | 3:00 AM | 17 | 92 | Flowering stage |
| 107 | 4:00 AM | 18 | 92 | Flowering stage |
| 107 | 5:00 AM | 20 | 105 | Flowering stage |
| 107 | 5:15 AM | 50 | 261 | Flowering stage |
| 107 | 6:00 AM | 45 | 238 | Flowering stage |
| 107 | 7:00 AM | 47 | 247 | Flowering stage |
| 107 | 8:00 AM | 56 | 295 | Flowering stage |
| 107 | 8:10 AM | 58 | 306 | Flowering stage (rain) |
| 107 | 8:25 AM | 78 | 410 | Flowering stage (rain) |
| 107 | 9:00 AM | 65 | 340 | Flowering stage (rain) |
| 107 | 10:00 AM | 68 | 357 | Flowering stage (rain) |
| 107 | 11:00 AM | 76 | 398 | Flowering stage (rain) |
| 107 | 12:00 PM | 89 | 468 | Flowering stage (rain) |
| 107 | 1:00 PM | 92 | 482 | Flowering stage (rain) |
| 107 | 2:00 PM | 91 | 475 | Flowering stage (rain) |
| 107 | 3:00 PM | 114 | 598 | Flowering stage (rain) |
| 107 | 3:50 PM | 134 | 700 | Flowering stage (rain) |
| 107 | 5:00 PM | 128 | 669 | Flowering stage (rain) |
| 107 | 6:00 PM | 135 | 706 | Flowering stage (rain) |
| 107 | 6:30 PM | 128 | 673 | Flowering stage (rain) |
| 107 | 7:00 PM | 126 | 659 | Flowering stage (rain) |
| 107 | 8:00 PM | 123 | 646 | Flowering stage (rain) |
| 107 | 9:00 PM | 137 | 715 | Flowering stage (rain) |
| 107 | 10:00 PM | 140 | 734 | Flowering stage (rain) |
| 107 | 11:00 PM | 151 | 791 | Flowering stage (rain) |
| 108 | 12:00 AM | 149 | 778 | Flowering stage (rain) |
| 116 | 2:00 AM | −37 | −192 | Senescence stage |
| 116 | 3:00 AM | −37 | −191 | Senescence stage |
| 116 | 4:00 AM | −36 | −190 | Senescence stage |
| 116 | 5:00 AM | −35 | −183 | Senescence stage |
| 116 | 6:00 AM | −35 | −185 | Senescence stage |
| 116 | 7:00 AM | −34 | −180 | Senescence stage |
| 116 | 8:00 AM | −32 | −167 | Senescence stage |
| 116 | 9:00 AM | 0 | 3 | Senescence stage |
| 116 | 10:00 AM | 3 | 17 | Senescence stage |
| 116 | 11:00 AM | −8 | −45 | Senescence stage |
| 116 | 12:00 PM | −12 | −64 | Senescence stage |
| 116 | 1:00 PM | −14 | −74 | Senescence stage |
| 116 | 2:00 PM | −17 | −93 | Senescence stage |
| 116 | 3:00 PM | −15 | −78 | Senescence stage |
| 116 | 4:00 PM | −15 | −80 | Senescence stage |
| 116 | 5:00 PM | −14 | −76 | Senescence stage |
| 116 | 6:00 PM | −13 | −69 | Senescence stage |
| 116 | 7:00 PM | 0 | 0 | Senescence stage |
| 116 | 8:00 PM | −3 | −19 | Senescence stage |
| 116 | 9:00 PM | −14 | −73 | Senescence stage |
| 116 | 10:00 PM | −1 | −8 | Senescence stage |
| 116 | 11:00 PM | −11 | −58 | Senescence stage |
| 117 | 12:00 AM | −21 | −113 | Senescence stage |

Conclusions: The values of the current flow and of the voltage were increased during the rains, then they were slowly being stabilizing to their normal values at the vegetative stage of the plants, which were kept high at the flowering stage. For this last stage, greater values of current were observed up to the filling of grains, then at the senescence stage the values were negative.

### Examples of Application

### Example of Application 1: Trial of Resistance to Drought of the Corn Pioneer 1833 HX in Pots

The trial consisted of plastic pots, all of them of the same size of 10 cm of diameter, 7.85×10⁻³ m² containing 2 plants of corn Pioneer 1833 HX each at the same V3 vegetative stage. The trial was made in triplicate. Plants were irrigated during 3 days and then water was suspended during 8-10 days in pots 1 and 2, and it was kept in pot 3.

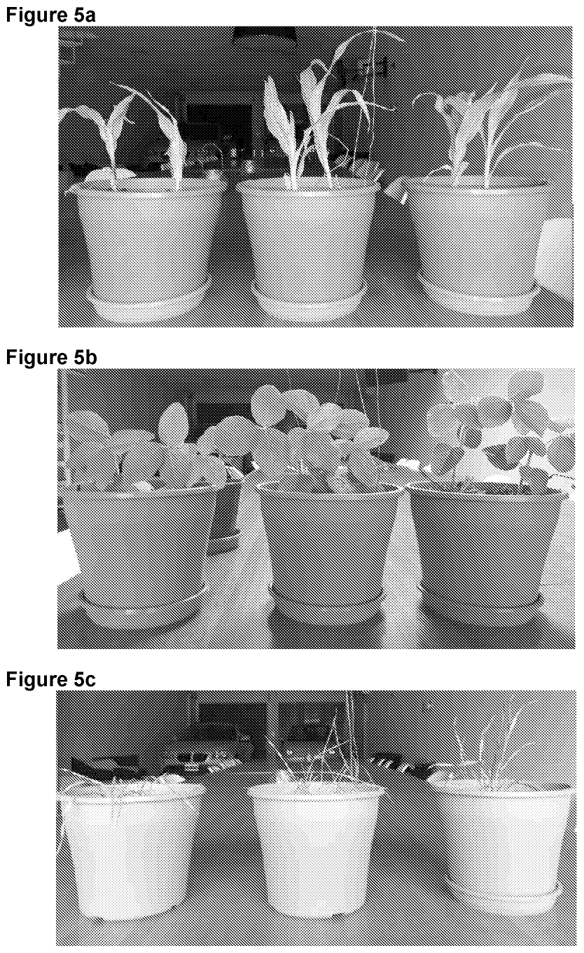

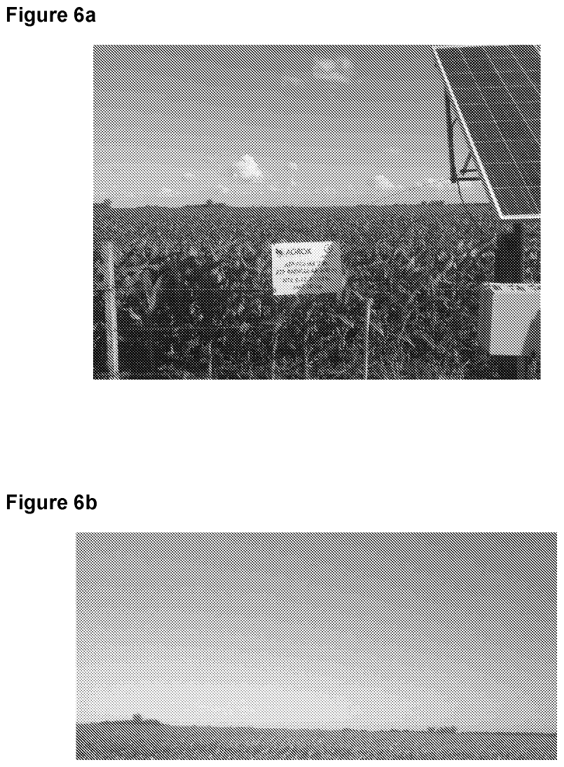

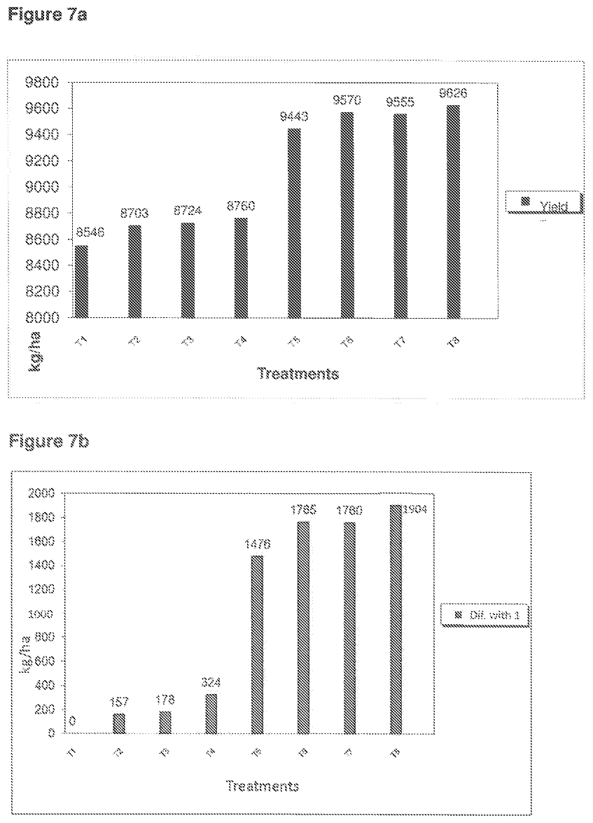

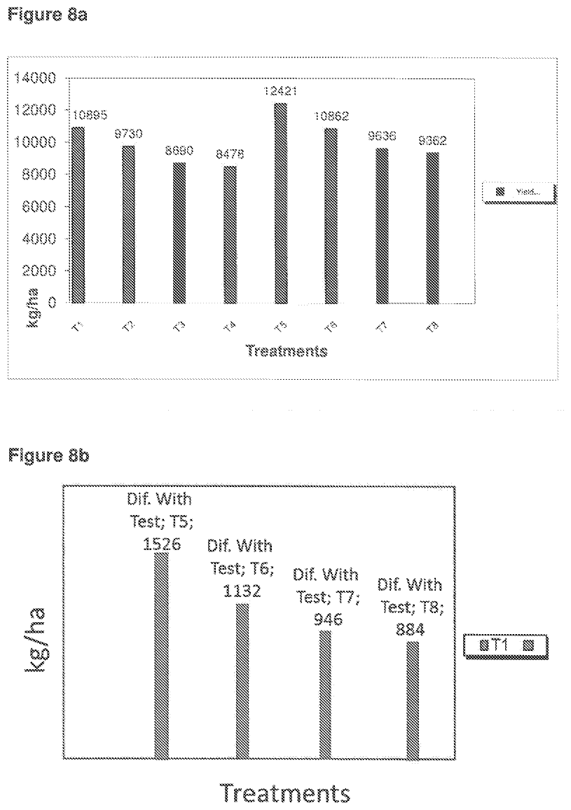

The pot 1 at the left of the FIG. 5a is the witness pot, it was kept without irrigation during a period of 8-10 days.

The pot 2 at the center of the FIG. 5a is the pot with the electroprotonic irrigation system, without irrigation during a period of 10 days. According to the image, on day 1 of the trial the zinc and copper electrodes in the form of an L, were buried, the electrode in the form of an L was folded, the short part was buried at 7 cm of depth and the large part of the L was left as an antenna, at the ends of the pot with East and West orientation, respectively. In this way, the component II was positioned.

The pot 3 at the right of FIG. 5a is the pot with irrigation where water on the order of 5 cm³ was applied per day with a pipette to each plant of said pot near the root.

The component I (N), a liquid protonated nitrogenous fertilizer of equivalent degree NPK 27-0-0 +3.20S+0.3Zn+0.1Fe+0.1Mg+0.20H⁺, was applied to the three pots at a dose on the order of 300 kg per hectare (240 mg/pot) so that no difference appears in the nutrition of the plants due to the micronutrients and nitrogen that this component has in its formulation apart from the protons.

After this period, a qualitative visual “score of drought” of 0-6 was assigned in order to register the degree of visible symptoms of stress due to drought. A score of “6” corresponded to non-visible symptoms, while a score of “0” corresponded to extreme withering and that the leaves had a “crunchy” texture. At the end of the drought period, the pots were irrigated again and were scored after 5-6 days; the number of surviving plants were counted in each pot and the proportion of total plants was calculated in the pots that survived.

The results obtained were the following:

The pot 1 was assigned, after the drought period, a score of 1, none of the plants survived when they were irrigated again and the final score was 0.

The pot 2 was assigned, after the drought period, a score of 5, and all the plants survived when they were irrigated again obtaining a final score of 6.

The pot 3 was assigned, after the trial period, a score of 6.

Conclusions: It was observed that the electroprotonic irrigation system gave a substantially unexpected result due to the fact that the “score of drought” of 6 at the end of the trial of the corn plants was comparable to the one obtained with regular irrigation. This showed a noticeable difference with respect to the corn plants under water stress due to drought.

### Example of Application 2: Trial of Resistance to Drought of the Soya Bean Nidera NS 5258 in Pots

The trial consisted of three plastic pots, all of them of the same size of 10 cm of diameter, 7.85×10⁻³ m² containing 2 plants of soya been Nidera NS 5258, each at the same V2 vegetative stage. The trial was made in triplicate. Plants were irrigated during 3 days and then water was suspended during 18-20 days in pots 1 and 2, and it was kept in pot 3.

The pot 1 at the left of the FIG. 5b is the witness pot, it was kept without irrigation during a period of 18-20 days.

The pot 2 at the center of the FIG. 5b is the pot with the corresponding electroprotonic irrigation system, without irrigation during a period of 18 -20 days. According to the image, on day 1 of the trial the zinc and copper electrodes in the form of an L, were buried, the electrode in the form of an L was folded, the short part was buried at 7 cm of depth and the large part of the L was left as an antenna, at the ends of the pot with East and West orientation, respectively. In this way, the component II was positioned.

The pot 3 at the right of FIG. 5b is the pot with irrigation where water on the order of 5 cm³ was applied per day with a pipette to each plant of said pot near the root.

The component I (N, P), a liquid protonated nitrogen phosphorous fertilizer of equivalent degree NPK 4-18-0 +5S+0.8Zn+0.4Fe+0.3Mg+0.33H+ was applied to the three pots at a dose on the order of 100 kg per hectare (78.5 mg/pot) so that no difference appears in the nutrition of the plants due to the micronutrients that this component has in its formulation apart from the protons.

After this period a qualitative visual “score of drought” of 0-6 was assigned in order to register the degree of visible symptoms of stress due to drought. A score of “6” corresponded to non-visible symptoms, while a score of “0” corresponded to extreme withering and that the leaves had a “crunchy” texture. At the end of the drought period, the pots were irrigated again and were scored after 5-6 days; the number of surviving plants were counted in each pot and the proportion of total plants was calculated in the pots that survived.

The results obtained were the following:

The pot 1 was assigned, after the drought period, a score of 4, all of the plants survived when they were irrigated again and the final score was 5.

The pot 2 was assigned, after the drought period, a score of 5, and all the plants survived when they were irrigated again obtaining a score at the end of the trial of 6.

The pot 3 was assigned, after the trial period, a score of 6.

Conclusions: It was observed that the electroprotonic irrigation system showed a completely unexpected result, the “score of drought” of 6 at the end of the trial of the soya bean plants was comparable to that of regular irrigation, showing a qualitatively detectable difference with respect to the soya bean plants under water stress due to drought.

### Example of Application 3: Trial of Resistance to Drought of the Wheat in Pots

The trial consisted of three plastic pots, all of them of the same size of 10 cm of diameter, 7.85×10⁻³ m² containing 4 plants of wheat BAGUETTE 601, each at the same vegetative stage 3 full tillering. The trial was made in triplicate. Plants were irrigated during 3 days and then water was suspended during 18-20 days in pots 1 and 2, and it was kept in pot 3.

The pot 1 at the left of the FIG. 5c is the witness pot, it was kept without irrigation during a period of 18-20 days.

The pot 2 at the center of the FIG. 5c is the pot with the corresponding electroprotonic irrigation system, without irrigation during a period of 18 -20 days.

On day 1 of the trial the zinc and copper electrodes in the form of an L, were buried, the electrode in the form of an L was folded, the short part was buried at 3 cm of depth and the large part of the L was left as an antenna, at the ends of the pot with East and West orientation, respectively. In this way, the component II was positioned.

The pot 3 at the right of FIG. 5c is the pot with irrigation where water on the order of 5 cm³ was applied per day with a pipette to each plant of said pot near the root.

The component 1 (N), a liquid protonated nitrogen fertilizer of equivalent degree NPK 27-0-0 +3.20S+0.3Zn+0.1Fe+0.1Mg+0.20H+ was applied to the three pots at a dose on the order of 350 kg per hectare (275 mg/pot) so that no difference appears in the nutrition of the plants due to the micronutrients that this component has in its formulation apart from the protons.

After this period a qualitative visual “score of drought” of 0-6 was assigned in order to register the degree of visible symptoms of stress due to drought. A score of “6” corresponded to non-visible symptoms, while a score of “0” corresponded to extreme withering and that the leaves had a “crunchy” texture. At the end of the drought period, the pots were irrigated again and were scored after 5-6 days; the number of surviving plants were counted in each pot and the proportion of total plants was calculated in the pots that survived.

The results obtained were the following:

The pot 1 was assigned, after the drought period, a score of 4, and all the plants survived when they were irrigated again and the score was 5.

The pot 2 was assigned, after the drought period, a score of 6, and all the plants survived when they were irrigated again obtaining a score at the end of the trial of 6.

The pot 3 was assigned, after the trial period, a score of 6.

Conclusions: It may be inferred that the electroprotonic irrigation system gave a completely unexpected result due to the fact that the “score of drought” of 6 at the end of the trial of the wheat plants was comparable to the one obtained with regular irrigation. This showed a qualitatively detectable difference with respect to the wheat plants under water stress due to drought.

### Example of Application 4: Trial on a Field of Resistance to Drought in Corn

A trial was performed on a field of the agricultural establishment named Don Domingo located in Salto Grande, Santa Fe province, Argentina. The soil corresponds to class I of a very good productivity. Rains during the cycle of culture are shown in table 7; rains were regular during the cycle, but with periods of water stress due to drought in the flowering stage and of filling of grains. The experiment was made in a culture that was sowed by direct sowing (DS), at a distance of 52 cm between furrows, with soya bean as predecessor. Seeds of Pioneer 1833 HX were used.

The basic fertilization consisted of the application on the order of 70 kg/ha of monoammonium phosphate (MAP) and approximately 100 dm³ of liquid fertilizer NTX 9N-12P-7S located in the sowing. As fertilization in V3 vegetative stage, the component I, a liquid protonated fertilizer of equivalent degree NPK 0-0-0 +3.2S+0.8Zn+0.4Fe+0.3Mg+0.2H⁺, was applied by blasting among furrows on the order of ascending doses of 0 kg, 100 kg, 200 kg and 300 kg per hectare. At the trial, a randomized complete-block design was used with three repeats and 8 treatments. The purpose of this trial was to demonstrate the tolerance/resistance to drought under the system of the present invention and to determine the dose of component I. A detail of the treatments is presented in the following table 5.

TABLE 5
Treatments of the trial of resistance to drought in corn

| | | Component II | | |
|---|---|---|---|---|
| Treatment | Component I | (Zn/Cu) | Application | Localization |
| T1 | 0 kg/ha | No | | |
| T2 | 100 kg/ha | No | V3 | Blasting on |
| | | | | surface |
| T3 | 200 kg/ha | No | V3 | Blasting on |
| | | | | surface |
| T4 | 300 kg/ha | No | V3 | Blasting on |
| | | | | surface |
| T5 | 0 kg/ha | Yes | | |
| T6 | 100 kg/ha | Yes | V3 | Blasting on |
| | | | | surface |
| T7 | 200 kg/ha | Yes | V3 | Blasting on |
| | | | | surface |
| T8 | 300 kg/ha | Yes | V3 | Blasting on |
| | | | | surface |

The component II was placed only in half of the batch so as to compare with and without electronic stimulation with zinc and copper electrodes as previously described here, that is, they were buried at about 7 cm of depth and put together to the wire netting of the East and West sides, respectively.

The analysis of the soil of the experimental site is shown in table 6, where representatives results of the region are displayed.

TABLE 6
Analysis of the soil at the time of sowing

| | | N | N—NO₃ | P- | | | | | |
|---|---|---|---|---|---|---|---|---|---|
| MO | | total | kg/ha | Bray | S—SO₄ | K | Mg | Ca | Zn |
| % | pH | % | 0-60 | Ppm | Ppm | ppm | ppm | Ppm | Ppm |
| 2.6 | 5.8 | 0.130 | 81.3 | 12.1 | 8.3 | 530 | 225 | 1235 | 0.80 |

TABLE 7
Rains during the cycle of culture expressed in mm.

| October | November | December | January | February | March |
|---|---|---|---|---|---|
| 129 | 87 | 102 | 33 | 41 | 96 |

Sowing was manually carried out, with stationary threshing of the samples. In an aliquot of the harvest, the components of performance, the number of grains (NG) per ear and per m² and the weight of one thousand grains (P1000) were analyzed. In order to study of the results an analysis of variance, comparisons of means and a correlation analysis were carried out.

The results obtained are summarized in table 8.

TABLE 8
Results of trials

| | | | | | Difference | Difference |
|---|---|---|---|---|---|---|
| Treat- | Grains/ | Grains/ | P1000 | Yield | with | with T1 |
| ment | ear | m² | (g) | (kg/ha) | T1 (kg/ha) | (%) |
| T1 | 451 | 3318 | 258 | 8546 | 0 | 0 |
| T2 | 427 | 3213 | 271 | 8703 | 157 | 2 |
| T3 | 417 | 3091 | 282 | 8724 | 178 | 2 |
| T4 | 443 | 3208 | 273 | 8760 | 214 | 3 |
| T5 | 456 | 3428 | 277 | 9443 | 897 | 10 |
| T6 | 470 | 3623 | 265 | 9570 | 1023 | 12 |
| T7 | 465 | 3635 | 274 | 9555 | 1008 | 12 |
| T8 | 459 | 3618 | 278 | 9626 | 1080 | 13 |

Treatments T2, T3 and T4 were kept without electronic stimulation, varying the dose of the component I. Treatment T4 was the most effective of the three treatments, showing that the increase of the concentration of protons slightly increased the performance with respect to the witness T1, but it was not of significance.

Treatment T5 with respect to the witness T1, showed that the electronic stimulation is significantly important in the performance with an increase of 10%.

Treatments T6, T7 and T8 showed that the combination of the electronic stimulation and the ascending protonic gave a wonderfully unexpected result of up to 13% of increase in the performance with respect to witness T1.

Conclusions: The combination of the electronic stimulation and the protonic stimulation gave an increase in the performance of up to 13% with respect to witness T1, showing a clear resistance to water stress of the corn being treated.

### Comparative Examples

### Comparative Example 1: Trial of Resistance to Drought in Corn as Compared the Corn DEKALB DK 72-10VT3P Under Electroprotonic Irrigation with the Corn Resistant to Drought DEKALB DKC 5741

The trial was performed in 2 plastic pots of the same size of 10 cm of diameter, 7.85×10⁻³ m² of surface, where the pot 1 contained 2 plants of corn DEKALB DK 72-10VT3P and the pot 2 contained 2 plants of corn DEKALB DKC 5741 resistant to drought and extreme heat, each of them in the same V3 vegetative stage. The trial was made in triplicate. The pots were irrigated during 3 days and then water was suspended during a period of 15 days.

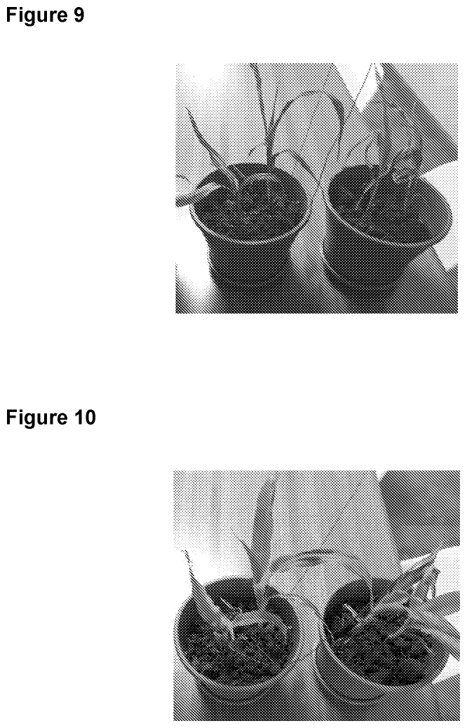

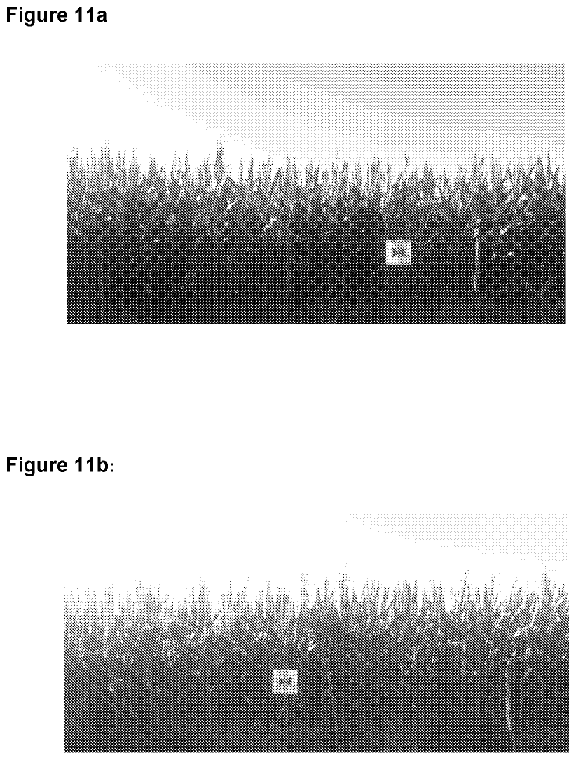

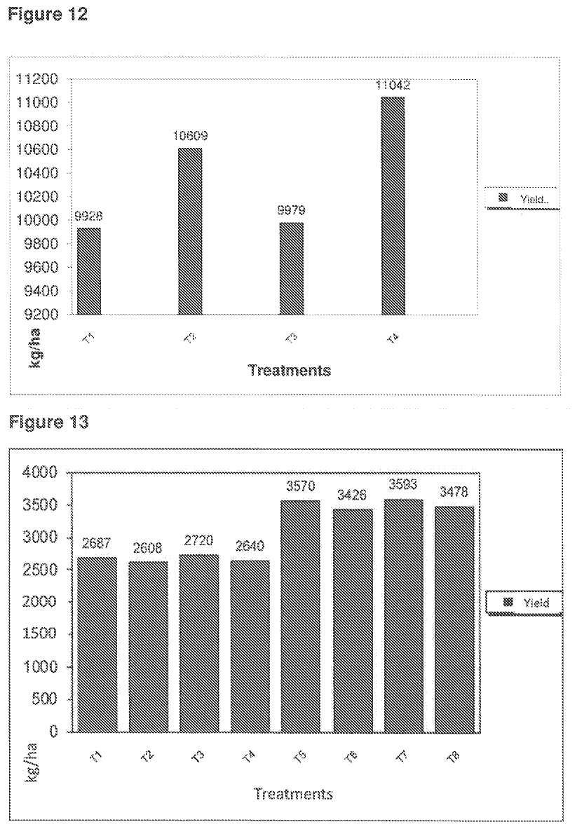

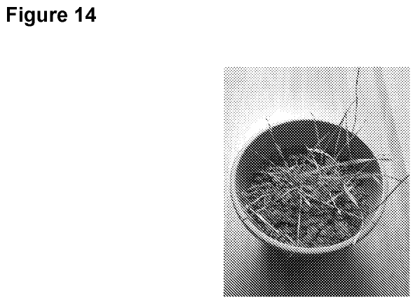

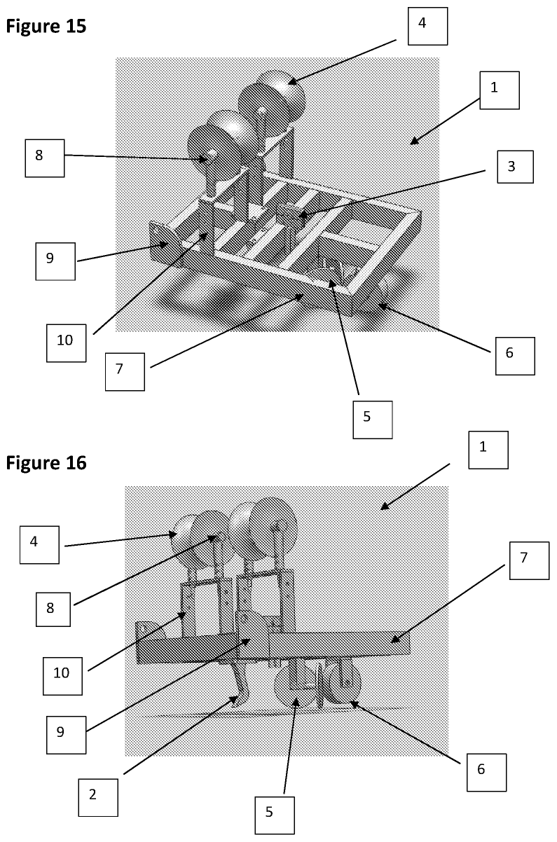

The pot 1 at the left of FIG. 9 is the pot corresponding to the electroprotonic irrigation system, without irrigation during a period of 15 days. According to the image, on day 1 of the trial the zinc and copper electrodes in the form of an L, were buried, with West and East orientation respectively, at a depth on the order of 7 cm. In this way, the component II was positioned.

The pot 2 at the right of FIG. 9 was the pot corresponding to the corn seed DEKALB DKC 5741 resistant to drought.

The component I (N), a liquid protonated nitrogen fertilizer of equivalent degree NPK 27-0-0 +3.20S+0.3Zn+0.1Fe+0.1Mg+0.20H+ was applied to the two pots at a dose on the order of 300 kg per hectare (240 mg/pot) so that no difference appears in the nutrition of the plants due to the micronutrients that this component has in its formulation apart from the protons.

After this period, a qualitative visual “score of drought” of 0-6 was assigned in order to register the degree of visible symptoms of stress due to drought. A score of “6” corresponded to non-visible symptoms, while a score of “0” corresponded to extreme withering and that the leaves had a “crunchy” texture. At the end of the drought period, the pots were irrigated again and were scored after 5 days; the number of surviving plants were counted in each pot and the proportion of total plants was calculated in the pots that survived.

The results obtained were the following:

The pot 1 was assigned, after the drought period, a score of 6, and all the plants survived when they were irrigated again obtaining a score at the end of the trial of 6.

The pot 2 was assigned, after the drought period, a score of 4, and all the plants survived when they were irrigated again obtaining a score at the end of the trial of 5.

Conclusions: It may be inferred that the electroprotonic irrigation system showed a superior result, the “score of drought” of 6 at the end of the trial of the corn plants showed a clear difference with the genetically modified seed DEKALB DKC 5741 resistant to drought.

### Comparative Example 2: Trial of Resistance to Drought in Corn as Compared the Corn DEKALB DK 4020 Under Electroprotonic Irrigation with the Corn Resistant to Drought KWS KEFIEROS FAO 700

The trial was performed in 2 plastic pots of the same size of 10 cm of diameter, 7.85×10⁻³ m² of surface, where the pot 1 contained 2 plants of corn KWS KM 4020 and the pot 2 contained 2 plants of corn KWS KEFIEROS FAO 700 resistant to drought and to extreme heat, each of them in the same V3 vegetative stage. The trial was made in triplicate. The pots were irrigated during 3 days and then water was suspended during a period of 15 days.

The pot 1 at the left of FIG. 10 was the pot corresponding to the electroprotonic irrigation system, without irrigation during a period of 15 days. According to the images, on day 1 of the trial the zinc and copper electrodes in the form of an L, were buried, with West and East orientation respectively, at a depth on the order of 7 cm. In this way, the component II was positioned.

The pot 2 at the right of FIG. 10 was the pot corresponding to the corn seed KWS KEFIEROS FAO 700 resistant to drought.

The component I (N), a liquid protonated nitrogen fertilizer of equivalent degree NPK 27-0-0 +3.20S+0.3Zn+0.1Fe+0.1Mg+0.20H+ was applied to the two pots at a dose on the order of 300 kg per hectare (240 mg/pot) so that no difference appears in the nutrition of the plants due to the micronutrients that this component has in its formulation apart from the protons.

After this period a qualitative visual “score of drought” of 0-6 was assigned in order to register the degree of visible symptoms of stress due to visible drought. A score of “6” corresponded to non-visible symptoms, while a score of “0” corresponded to extreme withering and that the leaves had a “crunchy” texture. At the end of the drought period, the pots were irrigated again and were scored after 5 days; the number of surviving plants were counted in each pot and the proportion of total plants was calculated in the pots that survived.

The results obtained were the following:

The pot 1 was assigned, after the drought period, a score of 5, and all the plants survived when they were irrigated again and the score at the end of the trial was of 6.

The pot 2 was assigned after the drought period a score of 4, and all the plants survived when they were irrigated again obtaining a score at the end of the trial of 5.

Conclusions: It may be inferred that the electroprotonic irrigation system showed a superior result, where the “score of drought” of 6 at the end of the trial of the corn plants KWS KM 4020 showed a clear difference with the genetically modified seed KWS KEFIEROS FAO 700 resistant to drought.

### Comparative Example 3: Trial on a Field of Resistance to Drought in Corn as Compared the Corns Resistant to Drought DEKALB DKC 5741 and KWS KEFIEROS FAO 700 with the Hybrid Corns Non-Resistant to Drought KWS KM 4020 and DEKALB DK 72-10VT3P with the Application of Electroprotonic Irrigation

A trial was performed on a field of the agricultural establishment named Estancia Morelli at Correa, Santa Fe province, Argentina. The soil corresponds to class I of good productivity. Rains during the cycle of culture are shown in table 11, they were regular during the cycle and ascended to 502 mm, but with periods of water stress due to drought in the flowering stage and of filling of grains. The experiment was made in a culture that was sowed by direct sowing (DS), at a distance of 52 cm between furrows, with soya bean as predecessor. Corn hybrids DEKALB DKC 5741, KWS KEFIEROS FAO 700, KWS KM 4020 and DEKALB DK 72-10VT3P. were used.

The basic fertilization consisted of the application on the order of 100 kg/ha of monoammonium phosphate (MAP) at the time of the sowing. A fertilization at V3 vegetative stage was applied by blasting to furrows on the order of 350 kg of a liquid fertilizer of equivalent degree NPK 27-0-0 +3.20S+0.3Zn+0.1Fe+0.1Mg, it was applied during treatments T1 and T3 so that no difference appears in the nutrition of the different corn hybrids due to the micronutrients that this component has in its formulation, apart from the protons, and the component I (N), a liquid protonated nitrogen fertilizer of equivalent degree NPK 27-0-0 +3.20S+0.3Zn+0.1Fe+0.1Mg+0.20H⁺ for treatments T2 and T4. At the trial, a randomized complete-block design was used with three repeats and 4 treatments. The purpose of this trial is to demonstrate the tolerance/resistance to drought under the system of the present invention as compared with the genetically modified seeds resistant to drought with a the basic fertilization in all treatments except in T2 and T4 where protons and electrons are added while in T1 and T3 there are no additions. A detail of the treatments performed are shown in the following table 9.

TABLE 9
Treatments of comparative trials of resistance to drought in corn

| Treat- | | | Component II | Appli- | |
|---|---|---|---|---|---|
| ment | Hybrids | Component I | (Zn/Cu) | cation | Localization |
| T1 | KWS | No. 350 | No | V3 | Blasting |
| | KEFIEROS | kg/ha of 27- | | | on surface |
| | FAO 700 | 0-0 + 3S | | | |
| T2 | KWS KM | 350 kg/ha | Yes | V3 | Blasting |
| | 4020 | | | | on surface |
| T3 | DEKALB | No. 350 | No | V3 | Blasting |
| | DK 72- | kg/ha of 27- | | | on surface |
| | 10VT3P | 0-0 + 3S | | | |
| T4 | DEKALB | 350 kg/ha | Yes | V3 | Blasting |
| | DKC 5741 | | | | on surface |

The component II for the electroprotonic stimulation was continuously applied with copper and zinc electrodes which are placed as referred to in the description of the component II previously given, buried at about 7 cm of depth and put together to the wire netting of the West and East sides, respectively.

The analysis of the soil of the experimental site is shown in table 10, where representative results of the region are displayed.

TABLE 10
Analysis of the soil at the time of sowing

| | | N | N—NO₃ | P- | | | | | |
|---|---|---|---|---|---|---|---|---|---|
| MO | | total | kg/ha | Bray | S—SO₄ | K | Mg | Ca | Zn |
| % | pH | % | 0-60 | Ppm | Ppm | ppm | ppm | Ppm | Ppm |
| 2.2 | 6.4 | 0.123 | 78.1 | 10.9 | 6.8 | 510 | 134 | 1357 | 0.67 |

TABLE 11
Rains during the cycle of culture expressed in mm.

| October | November | December | January | February | March |
|---|---|---|---|---|---|
| 133 | 103 | 97 | 37 | 40 | 92 |

Sowing was manually carried out, with stationary threshing of the samples. On an aliquot of the harvest, the components of performance, the number of grains (NG) per ear and per m2 and the weight of 1,000 grains (P1000) were analyzed. In order to study of the results an analysis of variance, comparisons of means and a correlation analysis were carried out.

The results obtained are shown in the following table 12.

TABLE 12
Results of trials

| | Grains/ | Grains/ | P1000 | Yield |
|---|---|---|---|---|
| Treatment | ear | m² | (g) | (kg/ha) |
| T1 | 456 | 3533 | 281 | 9928 |
| T2 | 470 | 3976 | 267 | 10609 |
| T3 | 465 | 3663 | 272 | 9979 |
| T4 | 459 | 3944 | 280 | 11042 |

Treatments T2 and T4 yielded the best performances, corresponding to the electroprotonic irrigation.

Treatment T2 rendered 6.9% of increase in the performance over treatment T1 of the genetically modified hybrid resistant to drought of the same seedbed KWS showing the efficacy of the system of the present invention over the genetically modified seeds resistant to drought.

Treatment T4 rendered 10.7% of increase in the performance over treatment T3 of the genetically modified hybrid resistant to drought of the same seedbed Monsanto DEKALB, showing the efficacy of the system of the present invention over the genetically modified seeds resistant to drought.

Conclusions: It may be arrived to the conclusion that the application of electroprotonic stimulation gives an increase of performance over the corn hybrid non-resistant to drought, over the genetically modified corns resistant to drought during the water stress caused by drought.

### Comparative Example 4: Trial on a Field of Resistance to Drought in Corn as Compared the Hybrid Corns of Monsanto DK692 MG RR2 Syngenta NK 900 TDT6, Dow M515 Hx RR2 and Pioneer P2049 Y, with and without an Electroprotonic Irrigation System

A trial was performed on a field of the agricultural establishment named Estancia Morelli at Correa, Santa Fe province, Argentina. The soil corresponds to class I of good productivity. Rains during the cycle of culture are shown in table 15, they were regular during the cycle, but with periods of water stress due to drought in the flowering stage and of filling of grains. The experiment was made in a culture that was sowed by direct sowing (DS), at a distance of 52 cm between furrows, with soya bean as predecessor Corn hybrids Monsanto DK692 MG RR2, Syngenta NK 900 TDT6 Nidera Ax 870 MG and Pioneer P2049 Y were used.

The basic fertilization consisted of the application on the order of 100 kg/ha of monoammonium phosphate (MAP) that were applied at the time of the sowing. A fertilization in V3 vegetative stage was applied by blasting to furrows on the order of 350 kg of the component I (N), a liquid protonated nitrogenous fertilizer of equivalent degree NPK 27-0-0 +3.20S+0.3Zn+0.1Fe+0.1Mg+0.20H⁺. At the trial, a randomized complete-block design was used with three repeats and 8 treatments. The purpose of this trial is to demonstrate the tolerance/resistance to drought under the system of the present invention as compared with the genetically modified seeds resistant to drought. A detail of the treatments performed are shown in the following table 13.

TABLE 13
Treatments of comparative trials of resistance to drought in corn

| Treat- | | | Component II | Appli- | |
|---|---|---|---|---|---|
| ment | Hybrids | Component I | (Zn/Cu) | cation | Localization |
| T1 | Monsanto | 350 kg/ha | No | V3 | Blasting on |
| | DK692 MG | | | | surface |
| | RR2 | | | | |
| T2 | Syngenta | 350 kg/ha | No | V3 | Blasting on |
| | NK 900 | | | | surface |
| | TDT6 | | | | |
| T3 | Nidera Ax | 350 kg/ha | No | V3 | Blasting on |
| | 870 MG | | | | surface |
| T4 | Pioneer | 350 kg/ha | No | V3 | Blasting on |
| | P2049 Y | | | | surface |
| T5 | Monsanto | 350 kg/ha | Yes | V3 | Blasting on |
| | DK692 MG | | | | surface |
| | RR2 | | | | |
| T6 | Syngenta | 350 kg/ha | Yes | V3 | Blasting on |
| | NK 900 | | | | surface |
| | TDT6 | | | | |
| T7 | Nidera Ax | 350 kg/ha | Yes | V3 | Blasting on |
| | 870 MG | | | | surface |
| T8 | Pioneer | 350 kg/ha | Yes | V3 | Blasting on |
| | P2049 Y | | | | surface |

The component I (N), a liquid protonated nitrogen fertilizer of equivalent degree NPK 27-0-0 +3.20S+0.3Zn+0.1Fe+0.1Mg+0.20H+ was applied to each treatment at a dose on the order of 350 kg per hectare so that no difference appears in the nutrition of the different corn hybrids due to the micronutrients that this component has in its formulation apart from the protons.

The component II was placed in order to enable the electronic stimulation to be continuous with zinc and copper electrodes placed in the form as previously described here, that is, they were buried at about 7 cm of depth and put together to the wire netting of the East and West sides, respectively.

The analysis of the soil of the experimental site is shown in table 14, where representative results of the region are displayed.

TABLE 14
Analysis of the soil at the time of sowing

| | | N | N—NO₃ | P- | | | | | |
|---|---|---|---|---|---|---|---|---|---|
| MO | | total | kg/ha | Bray | S—SO₄ | K | Mg | Ca | Zn |
| % | pH | % | 0-60 | ppm | Ppm | Ppm | ppm | Ppm | Ppm |
| 2.2 | 6.4 | 0.123 | 78.1 | 10.9 | 6.8 | 510 | 134 | 1357 | 0.67 |

TABLE 15
Rains during the cycle of culture expressed in mm.

| October | November | December | January | February | March |
|---|---|---|---|---|---|
| 133 | 103 | 97 | 37 | 40 | 92 |

Sowing was manually carried out, with stationary threshing of the samples. On an aliquot of the harvest, the components of performance, the number of grains (NG) per ear and per m2 and the weight of 1,000 grains (P1000) were analyzed. In order to study of the results an analysis of variance, comparisons of means and a correlation analysis were carried out.

The results obtained are shown in the following table 16.

TABLE 16
Results of trials

| | | | | | Difference | Difference |
|---|---|---|---|---|---|---|
| Treat- | Grains/ | Grains/ | P1000 | Yield | with | with T1 |
| ment | ear | m² | (g) | (kg/ha) | T1 (kg/ha) | (%) |
| T1 | 415 | 4230 | 258 | 10895 | — | — |
| T2 | 462 | 4151 | 234 | 9730 | — | — |
| T3 | 413 | 3402 | 255 | 8690 | — | — |
| T4 | 450 | 3547 | 239 | 8478 | — | — |
| T5 | 417 | 4308 | 288 | 12421 | 1526 | 14 |
| T6 | 464 | 4172 | 260 | 10862 | 1132 | 12 |
| T7 | 423 | 3382 | 285 | 9636 | 946 | 11 |
| T8 | 459 | 3618 | 259 | 9362 | 884 | 10 |

Treatments T5 to T8 rendered the greatest performances, being all of them corresponding to the treatment by electroprotonic irrigation.

Treatment T5 rendered an increase in the performance of 14% over treatment T1; that is, the same hybrid Monsanto DK692 MG RR2 under the same conditions gave a noticeable increase of performance with the application of electroprotonic irrigation.

Treatment T6 rendered an increase in the performance of 12% over treatment T2; that is, the same hybrid Syngenta NK 900 TDT6 gave a noticeable increase of performance with the application of electroprotonic irrigation.

Treatment T7 rendered an increase in the performance of 11% over treatment T3; that is, the same hybrid Nidera Ax 870 MG gave an increase of performance with the application of electroprotonic irrigation.

Treatment T8 rendered an increase in the performance of 10% over treatment T4; that is, the same hybrid Pioneer P2049 Y under the same conditions gave an increase of performance with the application of electroprotonic irrigation.

Conclusions: It may be observed that the combination of the electroprotonic stimulation renders an increase in the performance over the corn hybrids in this comparative trial, being directly proportional to the potential of the hybrid. It may be estimated that as the potentials of the yields of the new commercial hybrids increase, the present invention will be more effective.

### Comparative Example 5: Trial on a Field of Resistance to Drought in Wheat as Compared the Wheat Baguette 801 Premium, ACA 307, KLEIN Gladiador and SY 110 with and without an Electroprotonic Irrigation System

A trial was performed on a field of the agricultural establishment named Estancia Chamorro at Correa, Santa Fe province, Argentina. The soil corresponds to class I of good productivity. Rains during the cycle of culture are shown in table 19 where the existence of water stress during the period of trial is shown. The experiment was made in a culture that was sowed over crop residues of soya bean of first class, at a distance of 20 cm between furrows. Baguette 801 Premium, ACA 307, KLEIN Gladiador and SY 100 were used.

The basic fertilization consisted of the application on the order of 80 kg/ha of monoammonium phosphate (MAP) that were applied at the time of the sowing. A fertilization under tillering was applied on the order of 370 kg of the component I (N), a liquid protonated nitrogenous fertilizer of equivalent degree NPK 27-0-0 +3.20S+0.3Zn+0.1Fe+0.1Mg+0.20H⁺. At the trial, a randomized complete-block design was used with three repeats and eight treatments. The purpose of this trial was to demonstrate the tolerance/resistance to drought under the system of the present invention as compared with the same varieties without application of the mentioned system. A detail of the treatments performed are shown in the following table 17.

TABLE 17
Treatments of comparative trials of resistance to drought in wheat

| Treat- | | | Component II | Appli- | |
|---|---|---|---|---|---|
| ment | Hybrids | Component I | (Zn/Cu) | cation | Localization |
| T1 | Baguette | 370 kg/ha | No | Tillering | Blasting on |
| | 801 | | | | surface |
| | Premium | | | | |
| T2 | ACA 307 | 370 kg/ha | No | Tillering | Blasting on |
| | | | | | surface |
| T3 | KLEIN | 370 kg/ha | No | Tillering | Blasting on |
| | Gladiador | | | | surface |
| T4 | SY 110 | 370 kg/ha | No | Tillering | Blasting on |
| | | | | | surface |
| T5 | Baguette | 370 kg/ha | Yes | Tillering | Blasting on |
| | 801 | | | | surface |
| | Premium | | | | |
| T6 | ACA 307 | 370 kg/ha | Yes | Tillering | Blasting on |
| | | | | | surface |
| T7 | KLEIN | 370 kg/ha | Yes | Tillering | Blasting on |
| | Gladiador | | | | surface |
| T8 | SY 110 | 370 kg/ha | Yes | Tillering | Blasting on |
| | | | | | surface |

The component I (N), a liquid protonated nitrogen fertilizer of equivalent degree NPK 27-0-0 +3.20S+0.3Zn+0.1Fe+0.1Mg+0.20H+ was applied to each treatment at a dose on the order of 370 kg per hectare so that no difference appears in the nutrition of the different varieties of wheat due to the micronutrients that this component has in its formulation apart from the protons.

The component II was placed in order to enable the electronic stimulation to be continuous with zinc and copper electrodes placed in the form as previously described here, that is, they were buried at about 7 cm of depth and put together to the wire netting of the East and West sides, respectively.

The analysis of the soil of the experimental site is shown in table 18, where representative results of the region are displayed.

TABLE 18
Analysis of the soil at the time of sowing

| | | N | N—NO₃ | P- | | | | | |
|---|---|---|---|---|---|---|---|---|---|
| MO | | total | kg/ha | Bray | S—SO₄ | K | Mg | Ca | Zn |
| % | pH | % | 0-60 | ppm | Ppm | ppm | ppm | Ppm | Ppm |
| 2.8 | 6.2 | 0.135 | 83 | 14.1 | 9.1 | 450 | 135 | 879 | 0.32 |

TABLE 19
Rains during the cycle of culture expressed in mm.

| June | July | August | September | October | November |
|---|---|---|---|---|---|
| 20 | 13 | 5 | 26 | 70 | 106 |

The harvest was carried out with a harvester and it was weighed on an auto-downloadable trailer with a loading cell. In order to study the results an analysis of variance, comparisons of means and a correlation analysis were carried out.

The results obtained are shown in the following table 20.

TABLE 20
Results of trials

| | | Difference with | Difference |
|---|---|---|---|
| | Yield | the reference Ia | with the |
| Treatment | (kg/ha) | (kg/ha) | reference (%) |
| T1 | 4032 | — | — |
| T2 | 4203 | — | — |
| T3 | 3910 | — | — |
| T4 | 4552 | — | — |
| T5 | 4505 | 473 | 12 |
| T6 | 4760 | 557 | 13 |
| T7 | 4390 | 480 | 12 |
| T8 | 5154 | 602 | 13 |

Treatments T6 to T8 rendered greater performances, on the order of 12-13% over the same variety without electroprotonic irrigation.

Treatment T5 rendered an increase in the performance of 12% over treatment T1; that is, the same wheat Baguette 801 Premium under the same conditions gave a noticeable increase of performance with the application of electroprotonic irrigation.

Treatment T6 rendered an increase in the performance of 13% over treatment T2; that is, the same wheat ACA 307 gave a noticeable increase of performance with the application of electroprotonic irrigation.

Treatment T7 rendered an increase in the performance of 12% over treatment T3; that is, the same wheat KLEIN Gladiador gave an increase of performance with the application of electroprotonic irrigation.

Treatment T8 rendered an increase in the performance of 13% over treatment T4; that is, the same wheat SY 110 under the same conditions gave an increase of performance with the application of electroprotonic irrigation.

Conclusions: It may be concluded that the combination of the electroprotonic irrigation renders an increase in the performance over the same varieties of wheat in this comparative trial.

### Comparative Example 6: Trial on a Field of the Performance, in a Regular Year, of Soya Bean as Compared the Varieties of the Short Cycle III ACA 3535 GR and DM 3312 and the Large Cycle III SRM 3970 and SP 3×7, with and without the Electroprotonic Irrigation

A trial was performed on a field of the agricultural establishment named Estancia Don Domingo at Correa, Santa Fe province, Argentina. The soil corresponds to class I of good productivity. Rains during the cycle of culture are shown in table 23. Said rains were regular during the cycle of trial. The experiment was made in a culture that was sowed over crop residues of corn, at a distance of 52 cm between furrows. Soya bean was used as compared the varieties of the short cycle III ACA 3535 GR and DM 3312 and the large cycle III SRM 3970 and SP 3×7 with each other, with and without the electroprotonic irrigation At the trial, a randomized complete-block design was used with three repeats and eight treatments. The purpose of this trial was to demonstrate the performance under the application of the electroprotonic irrigation system of the present invention as compared with the same varieties without the application of said system. A detail of the treatments performed are shown in the following table 21.

TABLE 21
Treatments of comparative trials in soya bean

| Treat- | | | Component II | | Local- |
|---|---|---|---|---|---|
| ment | Hybrids | Component I | (Zn/Cu) | Application | ization |
| T1 | ACA | 100 kg/ha | No | 7 days post- | Blasting on |
| | 3535 GR | | | emergence | surface |
| T2 | DM 3312 | 100 kg/ha | No | 7 days post- | Blasting on |
| | | | | emergence | surface |
| T3 | SRM | 100 kg/ha | No | 7 days post- | Blasting on |
| | 3970 | | | emergence | surface |
| T4 | SP 3 × 7 | 100 kg/ha | No | 7 days post- | Blasting on |
| | | | | emergence | surface |
| T5 | ACA | 100 kg/ha | Yes | 7 days post- | Blasting on |
| | 3535 GR | | | emergence | surface |
| T6 | DM 3312 | 100 kg/ha | Yes | 7 days post- | Blasting on |
| | | | | emergence | surface |
| T7 | SRM | 100 kg/ha | Yes | 7 days post- | Blasting on |
| | 3970 | | | emergence | surface |
| T8 | SP 3 × 7 | 100 kg/ha | Yes | 7 days post- | Blasting on |
| | | | | emergence | surface |

The component I (N, P), a liquid protonated nitrogen phosphorous fertilizer of equivalent degree NPK 4-18-0 +5S+0.8Zn+0.4Fe+0.3Mg+0.33H+ was applied to each treatment at a dose on the order of 100 kg per hectare so that no difference appears in the nutrition of the different varieties of soya bean due to the micronutrients that this component has in its formulation apart from the protons.

The component II was placed in order to enable the electronic stimulation to be continuous with zinc and copper electrodes placed in the form as previously described here, that is, they were buried at about 7 cm of depth and put together to the wire netting of the East and West sides, respectively.

The analysis of the soil of the experimental site is shown in table 22, where representative results of the region are displayed.

TABLE 22
Analysis of the soil at the time of sowing

| | | N | N—NO₃ | P- | | | | | |
|---|---|---|---|---|---|---|---|---|---|
| MO | | total | kg/ha | Bray | S—SO₄ | K | Mg | Ca | Zn |
| % | pH | % | 0-60 | Ppm | ppm | ppm | ppm | ppm | Ppm |
| 2.2 | 6.4 | 0.123 | 78.1 | 10.9 | 6.8 | 510 | 134 | 1357 | 0.67 |

TABLE 23
Rains during the cycle of culture expressed in mm.

| October | November | December | January | February | March |
|---|---|---|---|---|---|
| 133 | 103 | 97 | 45 | 52 | 92 |

The harvest was carried out with a harvester and it was weighed on an auto-downloadable trailer with a loading cell. In order to study the results an analysis of variance, comparisons of means and a correlation analysis were carried out.

The results obtained are shown in the following table 24.

TABLE 24
Results of trials

| | | Difference with | Difference with |
|---|---|---|---|
| | Yield | the reference | the reference |
| Treatment | (kg/ha) | (kg/ha) | (%) |
| T1 | 5089 | — | — |
| T2 | 5103 | — | — |
| T3 | 5112 | — | — |
| T4 | 5010 | — | — |
| T5 | 5490 | 401 | 8 |
| T6 | 5478 | 375 | 7 |
| T7 | 5367 | 255 | 5 |
| T8 | 5245 | 235 | 5 |

Treatments T5 and T6 rendered greater performances, on the order of 8 and 7%, respectively, with respect to the same variety without electroprotonic irrigation.

Treatment T5 rendered an increase in the performance of 8% over treatment T1; that is, the same soya bean ACA 3535 GR under the same conditions gave a noticeable increase of performance with the application of electroprotonic irrigation.

Treatment T6 rendered an increase in the performance of 7% over treatment T2; that is, the same soya bean DM 3312 gave an important increase of performance with the application of electroprotonic irrigation.

Treatment T7 rendered an increase in the performance of 5% over treatment T3; that is, the same soya bean SRM 3970 gave an increase of performance with the application of electroprotonic irrigation.

Treatment T8 rendered an increase in the performance of 5% over treatment T4; that is, the same soya bean SP 3×7 under the same conditions gave an increase of performance with the application of electroprotonic irrigation.

Conclusions: It may be observed that the combination of the electroprotonic irrigation renders an increase in the performance over the same varieties of soya bean in this comparative trial of application, in a year of regular rains. This shows that the system may be applied in all the environmental conditions, increasing, in each case, the performance and generating profitability to the producer in regular years, and profitability and security in years of drought or water stress.

### Comparative Example 7: Trial on a Field of the Performance, in a Year with Water Stress, of Soya Bean as Compared the Varieties of the Short Cycle III ACA 3535 GR and DM 3312 and the Large Cycle III SRM 3970 and SP 3×7, with and without the Electroprotonic Irrigation Using the Component I (N, S) via Foliar

A trial was performed on a field of the agricultural establishment named Estancia Don Domingo at Correa, Santa Fe province, Argentina. The soil corresponds to class I of good productivity. Rains during the cycle of culture are shown in table 25. Said rains were scarce during the cycle of trial.

The experiment was made in a culture that was sowed over crop residues of corn, at a distance of 52 cm between furrows. Soya bean was used as compared the varieties of the short cycle III ACA 3535 GR and DM 3312 and the large cycle III SRM 3970 and SP 3×7 with each other, with and without the electroprotonic irrigation At the trial, a randomized complete-block design was used with three repeats and eight treatments. The purpose of this trial was to demonstrate the performance under the application of the electroprotonic irrigation system of the present invention as compared with the same varieties without the application of said system. A detail of the treatments performed are shown in the following table 25.

TABLE 25
Treatments of comparative trials in soya bean

| Treat- | | Component I | Component II | | Local- |
|---|---|---|---|---|---|
| ment | Hybrids | (N, S) foliar | (Zn/Cu) | Application | ization |
| T1 | ACA | No | No | | |
| | 3535 GR | | | | |
| T2 | DM 3312 | No | No | | |
| T3 | SRM | No | No | | |
| | 3970 | | | | |
| T4 | SP 3 × 7 | No | No | | |
| T5 | ACA | 250 cm³/ha | Yes | 30 days post- | Via foliar |
| | 3535 GR | | | emergence | |
| T6 | DM | 250 cm³/ha | Yes | 30 days post- | Via foliar |
| | 3312 | | | emergence | |
| T7 | SRM | 250 cm³/ha | Yes | 30 days post- | Via foliar |
| | 3970 | | | emergence | |
| T8 | SP 3 × 7 | 250 cm³/ha | Yes | 30 days post- | Via foliar |
| | | | | emergence | |

The component I (N, S) a liquid foliar protonated nitrogen sulphurized fertilizer with glucose and L-tirosine of equivalent degree NPK 3.2-0-0 +3.6S+0.6Zn+0.55H⁺, was applied to treatments T5, T6, T7 and T8 at a dose on the order of 250 cm³ per hectare.

The component II was placed in order to enable the electronic stimulation to be continuous with zinc and copper electrodes placed in the form as previously described here, that is, they were buried at about 3 cm of depth and put together to the wire netting of the East and West sides, respectively.

The analysis of the soil of the experimental site is shown in table 25, where representative results of the region are displayed.

TABLE 26
Analysis of the soil at the time of sowing

| | | N | N—NO₃ | P- | | | | | |
|---|---|---|---|---|---|---|---|---|---|
| MO | | total | kg/ha | Bray | S—SO₄ | K | Mg | Ca | Zn |
| % | pH | % | 0-60 | Ppm | ppm | Ppm | ppm | Ppm | Ppm |
| 2.1 | 6.7 | 0.127 | 85.1 | 9.9 | 7.3 | 450 | 131 | 1047 | 0.24 |

TABLE 27
Rains during the cycle of culture expressed in mm.

| October | November | December | January | February | March |
|---|---|---|---|---|---|
| 89 | 67 | 102 | 32 | 37 | 0 |

The harvest was carried out with a harvester and it was weighed on an auto-downloadable trailer with a loading cell. In order to study the results an analysis of variance, comparisons of means and a correlation analysis were carried out.

The results obtained are shown in the following table 28.

TABLE 28
Results of trials

| | | Difference with | Difference with |
|---|---|---|---|
| | Yield | the reference | the reference |
| Treatment | (kg/ha) | (kg/ha) | (%) |
| T1 | 2687 | — | — |
| T2 | 2608 | — | — |
| T3 | 2720 | — | — |
| T4 | 2640 | — | — |
| T5 | 3570 | 883 | 32.9 |
| T6 | 3426 | 818 | 31.4 |
| T7 | 3593 | 873 | 32.1 |
| T8 | 3478 | 838 | 31.2 |

Treatments T5 and T7 rendered greater performances, on the order of 32.9 and 32.1%, respectively, with respect to the same variety without electroprotonic irrigation.

Treatment T5 rendered an increase in the performance of 32.9% over treatment T1; that is, the same soya bean ACA 3535 GR under the same conditions gave a noticeable increase of performance with the application of electroprotonic irrigation.

Treatment T6 rendered an increase in the performance of 31.4% over treatment T2; that is, the same soya bean DM 3312 gave an important increase of performance with the application of electroprotonic irrigation.

Treatment T7 rendered an increase in the performance of 32.1% over treatment T3; that is, the same soya bean SRM 3970 gave a significant increase of performance with the application of electroprotonic irrigation.

Treatment T8 rendered an increase in the performance of 31.2% over treatment T4; that is, the same soya bean SP 3×7 under the same conditions gave a noticeable increase of performance with the application of electroprotonic irrigation.

Conclusions: It may be observed that the combination of the electroprotonic irrigation renders an increase in the performance over the same varieties of soya bean in this comparative trial in a year with water stress. This shows that the system may be applied in all the unfavorable environmental conditions generating profitability and security in years of water stress.

1. A system for decreasing the impact of drought on the performance of a culture, CHARACTERIZED in that it comprises:
a component I that is a liquid fertilizer of radicular or foliar absorption that provides protons (H⁺), enzymatic, activator micro elements and, optionally, nitrogen (N) or nitrogen and phosphorus (N, P) or nitrogen, sulphur, glucose, and L-tirosine as metabolic activator (N, S); and
a component II which is a group of electrodes that generates an electric current that provides electrons (e⁻) of radicular absorption.

2. The system in accordance with claim 1, CHARACTERIZED in that the component I is a liquid protonated fertilizer that comprises sulphuric acid (98%) from about 8.0 to about 16% w/w, zinc oxide from about 0.5 to about 2.0% w/w, ferrous oxide from about 0.1 to about 1.0% w/w, magnesium oxide from about 0.1 to about 1.0% w/w and demineralised water csp 100.0% w/w.

3. The system in accordance with claim 2, CHARACTERIZED in that the component I a liquid fertilizer comprises sulphuric acid (98%) on the order of 10.0% w/w, zinc oxide on the order of 1.0% w/w, ferrous oxide on the order of 0.5% w/w, magnesium oxide on the order of 0.5% w/w, and demineralised water csp 100.0% w/w, constituting a component I, a liquid protonated fertilizer of equivalent degree NPK 0-0-0 +3.2S+0.8Zn+0.4Fe+0.3Mg+0.2H⁺.

4. The system in accordance with claim 2, CHARACTERIZED in that the component I comprises a source of nitrogen, incorporated, in such a way that the composition is constituted in a component I (N).

5. The system in accordance with claim 2, CHARACTERIZED in that the component I comprises a source of nitrogen and a source of phosphorous both incorporated, in such a way that the composition is constituted in a component I (N, P).

6. The system in accordance with claim 2, CHARACTERIZED in that the component I comprises a source of nitrogen, a source of sulphur, glucose and L-tirosine, all of them incorporated, in such a way that the composition is constituted in a component I (N, S).

7. The system in accordance with claim 4, CHARACTERIZED in that the component I (N) comprising a source of nitrogen incorporated, comprises in solution: urea (46% of N) from about 50 to about 60% w/w, ammonium nitrate from about 2 to about 5% w/w, sulphuric acid (98%) from about 8.0 to about 16% w/w, zinc oxide from about 0.1 to about 1.0% w/w, ferrous oxide from about 0.1 to about 1.0% w/w, magnesium oxide from about 0.1 to about 1.0% w/w and demineralised water csp 100.0% w/w.

8. The system in accordance with claim 7, CHARACTERIZED in that the component I (N) comprising a source of nitrogen incorporated, comprises in solution: urea (46% of N) on the order of 54% w/w, ammonium nitrate on the order of 3% w/w, sulphuric acid (98%) on the order of 10.0% w/w, zinc oxide on the order of 0.38% w/w, ferrous oxide on the order of 0.13% w/w, magnesium oxide on the order of 0.17% w/w, and demineralised water csp 100.0% w/w, constituting a liquid fertilizer protonated of equivalent degree NPK 27-0-0 +3.2S+0.3Zn+0.1 Fe+0.1 Mg+0.20H⁺.

9. The system in accordance with claim 5, CHARACTERIZED in that the component I (N, P) comprising a source of nitrogen and a source of phosphorous both incorporated, comprises in solution: mono-ammonium phosphate from about 20 to about 40% w/w, sulphuric acid (98%) from about 12.0 to about 20% w/w, zinc oxide from about 0.5 to about 2.0% w/w, ferrous oxide from about 0.1 to about 1.0% w/w, magnesium oxide from about 0.1 to about 1.0% w/w and demineralised water csp 100.0% w/w.

10. The system in accordance with claim 9, CHARACTERIZED in that the component I (N, P) comprising a source of nitrogen and a source of phosphorous both incorporated, comprises in solution: mono-ammonium phosphate on the order of 36% w/w, sulphuric acid (98%) on the order of 16% w/w, zinc oxide on the order of 1.0% w/w, ferrous oxide on the order of 0.5% w/w, magnesium oxide on the order of 0.5% w/w, and demineralised water csp 100.0% w/w, constituting a liquid protonated phosphorous nitrogen fertilizer of equivalent degree NPK 4-18-0 +5S+0.8Zn+0.4Fe+0.3Mg+0.33H⁺.

11. The system in accordance with claim 6, CHARACTERIZED in that the component I (N, S) of foliar application comprising a source of nitrogen, a source of sulphur, glucose and L-tirosine all of them incorporated, comprises in solution: hydrochloric acid 2 N from about 15 to about 25% w/v, ammonium sulphate from about 10 to about 25% w/v, glucose from about 10 to about 20% w/v, ethoxylated lauryl alcohol 7 moles of OE from about 5 to about 15% w/v, L-tirosine from about 0.5 to about 5% w/v, zinc oxide from about 0.5 to about 2% w/v, demineralised water csp 100.0% w/v.

12. The system in accordance with claim 11, CHARACTERIZED in that the component I (N, S) of foliar application comprising a source of nitrogen, a source of sulphur, glucose and L-tirosine all of them incorporated, comprises in solution: hydrochloric acid 2 N on the order of 20%, ammonium sulphate on the order of 25% w/v, glucose on the order of 14% w/v, ethoxylated lauryl alcohol 7 moles of OE on the order of 7% w/v, L-tirosine on the order of 3.3% w/v, zinc oxide on the order of 0.7% w/v, and demineralised water csp 100.0% w/v, constituting a liquid foliar protonated nitrogen sulphurized fertilizer with metabolic and enzymatic activators of equivalent degree NPK 3.2-0-0 +3.6S+0.6Zn+0.55H⁺.

13. The system in accordance with claim 1, CHARACTERIZED in that the component II is an electric circuit formed by two buried electrodes that are put together by one of its ends to a perimeter wire netting of the batch where the culture is located, wherein: the anode is of zinc and the cathode is of copper.

14. The system in accordance with claim 13, CHARACTERIZED in that the zinc anode is a wire from about 1.7 to about 5 mm of diameter buried from about 3 cm to about 7 cm in depth linearly, generating a continuous anode.

15. The system in accordance with claim 13, CHARACTERIZED in that the copper cathode is a wire from about 1.7 to about 5 mm of diameter buried from about 3 cm to about 7 cm in depth linearly, generating a continuous cathode.

16. The system in accordance with claim 14, CHARACTERIZED in that the zinc anode is arranged with a longitudinal orientation North-South or East-West on a side of a cultured batch and the copper cathode is arranged with a longitudinal orientation North-South or East-West on an opposite side of a cultured batch, in such a way that the electrodes are faced and parallel with one another.

17. The system in accordance with claim 16, CHARACTERIZED in that the zinc anode is arranged with a longitudinal orientation North-South on the East side of the cultured batch and the copper cathode is arranged with a longitudinal orientation North-South on the West side of the cultured batch, in such a way that the electrodes are faced and parallel with one another.

18. The system in accordance with claim 16, CHARACTERIZED in that the cathode and the anode are put together to a wire of a perimeter wire netting of the batch, said netting is parallel to said electrodes.

19. A method for preparing the component I, a liquid protonated fertilizer of equivalent degree NPK 0-0-0 +3.2S+0.8Zn+0.4Fe+0.3Mg+0.2H⁺, comprised in the system of claim 1, said method CHARACTERIZED in that it comprises:
a) adding sulphuric acid (98%) in demineralised water under stirring at 800 rmp and stabilizing the temperature of the solution at 25° C.;
b) adding zinc oxide , ferrous oxide and magnesium oxide under stirring, keeping stirring during 20 minutes and bringing to a volume with demineralised water; and
c) controlling the absence of precipitate or insoluble material, and filtering the solution in a vertical filter with a mesh of 300 microns and then with a mesh of 1 micron.

20. A method for preparing the component I (N), a liquid protonated nitrogenous fertilizer of equivalent degree NPK 27-0-0 +3.2S+0.3Zn+0.1Fe+0.1Mg+0.20H⁺, comprised in the system of claim 1, said method CHARACTERIZED in that it comprises:
a) adding sulphuric acid (98%) in demineralised water under stirring at 800 rpm, and then dissolving urea and keeping stirring up to complete dissolution taking advantage of the heat of dilution that was released;
b) adding ammonium nitrate keeping stirring up to total dissolution;
c) adding zinc oxide, ferrous oxide and magnesium oxide under stirring and keeping the stirring during 20 minutes and bringing to a volume with demineralised water; and
c) controlling the absence of a precipitate or insoluble material, and filtering the solution in a vertical filter with a mesh of 300 microns and then with a mesh of 1 micron.

21. A method for preparing the component I (N, P), a liquid protonated nitrogen phosphorous fertilizer of equivalent degree NPK 4-18-0 +5S+0.8Zn+0.4Fe+0.3Mg+0.33H⁺, comprised in the system of claim 1, said method CHARACTERIZED in that it comprises:
a) adding sulphuric acid (98%) in demineralised water under stirring at 800 rpm, and then dissolving monoammonium phosphate and keeping stirring up to complete dissolution taking advantage of the heat of dilution that was released;
b) upon stabilization of temperature at 25° C., adding zinc oxide , ferrous oxide and magnesium oxide under stirring, keeping stirring during 20 minutes and bringing to a volume with demineralised water to compensate the vaporized water; and
c) controlling the absence of precipitate or insoluble material, and filtering the solution in a vertical filter with a mesh of 300 microns and then with a mesh of 1 micron.

22. A method for preparing the component I (N, S), a liquid foliar protonated nitrogenous sulphurized fertilizer with metabolic and enzymatic activators of equivalent degree NPK 3.2-0-0 +3.6S+0.6Zn+0.55H⁺, comprised in the system of claim 1, said method CHARACTERIZED in that it comprises:
a) adding ammonium sulphate in demineralised water under stirring at about 1,000 rpm;
b) adding glucose under stirring;
c) then adding ethoxylated lauryl alcohol of 7 moles OE under stirring;
d) adding L-tirosine previously dissolved in hydrochloric acid 2 N also under stirring;
e) adding zinc oxide under stirring, keeping stirring during 25 minutes and bringing to a volume with demineralised water; and
f) controlling the absence of a precipitate or insoluble material, and filtering the solution in a vertical filter with a mesh of 300 microns and then with a mesh of 1 micron.

23. A system for decreasing the impact of drought on the performance of a culture, using the system in accordance with claim 1, CHARACTERIZED in that it comprises:
a) installing an anode and a cathode in a batch with an agricultural tool having a disk furrow opener, a wire attachment which is supplied with a roll at the top and a dead furrow formed by disks which are inclined and have a leveller wheel, wherein the anode is a wire of zinc and the cathode is a wire of copper;
b) connecting the anode and the cathode to the wire netting of the batch;
c) sowing the batch; and
d) applying the component I or the component I (N), or the component I (N, P), in pre-emergence or post-emergence of the culture, or the component (N, S) in post-emergence of the culture.

24. The method for decreasing the impact of drought on the performance of a culture in accordance with claim 23, CHARACTERIZED in that it comprises carrying out the step c) before the step a).

25. The method in accordance with claim 23, CHARACTERIZED in that the dose of application of the component I is from about 100 to about 300 kg per ha.

26. The method in accordance with claim 23, CHARACTERIZED in that the dose of application of component I (N) is from about 200 to about 400 kg per ha.

27. The method in accordance with claim 26, CHARACTERIZED in that the application is carried out in cultures of corn, sorghum, wheat, oats, barley and rainfed rice.

28. The method in accordance with claim 23, CHARACTERIZED in that the dose of application of component I (N, P) is from about 50 to about 150 kg per hectare.

29. The method in accordance with claim 28, CHARACTERIZED in that the application is carried out in cultures of soya bean.

30. The method in accordance with claim 23, CHARACTERIZED in that the dose of application of the component I (N, S) is from about 200 to about 500 cm³, diluted in about 50 to about 150 dm³ of water per ha.

31. The method in accordance with claim 30, CHARACTERIZED in that the application is carried out in a culture of soya bean, corn, sorghum, wheat, oats, barley and rainfed rice.

32. The method in accordance with claim 23, CHARACTERIZED in that the step d) of applying to the culture the component I or the component I (N), or the component I (N, P) is at a minimum from 7 days of pre-emergence to a maximum of 70 days of post-emergence of the culture, or the component I (N, S) is at a minimum from 15 days to a maximum of 70 days of post-emergence of the culture.

33. The method in accordance with claim 32, CHARACTERIZED in that the step d) of applying to the culture the component I or the component I (N), or the component I (N, P), or the component (N, S) is carried out at 30 days of post-emergence of the culture.

34. The method in accordance with claim 23, CHARACTERIZED in that the application of the component I or the component I (N), or the component I (N, P) is carried out by furrow blasting.

35. The method in accordance with claim 30, CHARACTERIZED in that the dose of application of component I (N, S) is carried out via foliar by spraying the total coverage.

36. The method in accordance with claim 34, CHARACTERIZED in that the blasting furrow is carried out in with blasting sprayer.

37. The method in accordance with claim 35, CHARACTERIZED in that the application via foliar by spraying the total coverage is carried out with sprayer by total coverage.

38. The method in accordance with claim 23, CHARACTERIZED in that the application of the component I or the component I (N), or the component I (N, P) is carried out in combination with a traditional solid fertilization.

39. The method in accordance with claim 38, CHARACTERIZED in that the application of the component I is carried out together with, at least, a solid nitrogenous fertilizer as a nutrient for corn, sorghum, wheat, oats, barley and rainfed rice.

40. The method in accordance with claim 39, CHARACTERIZED in that the solid nitrogenous fertilizer is selected of urea, ammonium nitrate, ammonium sulphate, ammonium nitrate and calcium carbonate, ammonium sulphanitrate and the mixtures thereof.

41. The method in accordance with claim 38, CHARACTERIZED in that the application of the component I is carried out together with, at least, a solid phosphorous fertilizer as starter for soya bean.

42. The method in accordance with claim 41, CHARACTERIZED in that the solid phosphorous fertilizer is selected of monoammonium phosphate (MAP), superphosphate simple (SPS), triple superphosphate or (SPT), milled rock phosphate and the mixtures thereof.

43. The method in accordance with claim 30, CHARACTERIZED in that the application of the component I (N, S) is carried out together with, at least, a compatible phytosanitary in cultures of soya bean, corn, sorghum, wheat, oats, barley and rainfed rice.

44. An agricultural tool to be used in the step a) of the method for decreasing the impact of drought on the performance of a culture of claim 23, CHARACTERIZED in that it comprises:
a horizontal chassis comprising anchorages in the front end to put together the tool to the motorized vehicle, above the chassis there are two supports which are symmetrically and transversally assembled in line and at the same height with axis, where the wires that constitute the electrodes are wrapped, and below said reels and in the middle of the chassis a wire winding is assembled for the wire to pass as the tool moves forward along the field; and
below the chassis and at the front of the tool, a furrow opener in the form of an U is centrally assembled, behind this opener two dead furrow disks are assembled inclined and faced in V and behind these disks a leveller wheel is assembled which levels out the furrow already closed, the dead furrow disks are regulated in height.

45. The agricultural tool of claim 44, CHARACTERIZED in that the anchorages in front of the chassis are located on the sides and enable the tool to be anchored in a version of 3 points or in a version of dragging.

46. The agricultural tool of claim 44, CHARACTERIZED in that the structure or chassis is manufactured of a structural tube.

47. The agricultural tool of claim 46, CHARACTERIZED in that the chassis has the following measures (40×80×4.75) cm, and is painted with epoxy paint.

48. The agricultural tool of claim 44, CHARACTERIZED in that the wires that form the electrodes are the anode which is formed by a wire of zinc and the cathode which is formed by a wire of copper.

49. The agricultural tool of claim 48, CHARACTERIZED in that the wires that form the electrodes anode and cathode are wires having from 1.7 to 5 mm of diameter.
